(19) United States
(12) Patent Application Publication
(10) Pub. No.: US 2025/0286655 A1
(43) Pub. Date: Sep. 11, 2025

(54) TECHNIQUES FOR LOW DENSITY PARITY CHECK RATE MATCHING

(71) Applicant: QUALCOMM Incorporated, San Diego, CA (US)

(72) Inventors: Jialing Li CHEN, San Diego, CA (US); Bin TIAN, San Diego, CA (US); Youhan KIM, Saratoga, CA (US); Sameer VERMANI, San Diego, CA (US)

(21) Appl. No.: 19/069,910

(22) Filed: Mar. 4, 2025

Related U.S. Application Data
(60) Provisional application No. 63/561,736, filed on Mar. 6, 2024.

(51) Int. Cl. H04L 1/00

(52) U.S. Cl. CPC H04L 1/0068; H04L 1/0057

(57) ABSTRACT

Methods, systems, and devices for wireless communication are described. The method may include a first wireless device generating one or more low density parity check (LDPC) codewords and adding one or more symbols or one or more symbol fractions to adjust a first boundary of a packet such that a puncturing ratio associated with the one or more LDPC codewords is reduced or set to zero. In some examples, the first boundary may specify a first number of symbols of the packet allocated for the one or more LDPC codewords. Further, the first wireless device may transmit, to a second wireless device, the packet comprising the one or more LDPC codewords based on the adjusted first boundary.

### CROSS REFERENCE

The present Application for Patent claims benefit of U.S. Provisional Patent Application 63/561,736 by Chen et al., entitled “TECHNIQUES FOR LOW DENSITY PARITY CHECK RATE MATCHING,” filed Mar. 6, 2024, which is assigned to the assignee hereof, and is expressly incorporated by reference herein.

### BACKGROUND

The following relates to wireless communication, including techniques for low density parity check (LDPC) rate matching.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a WLAN, such as a Wi-Fi (i.e., Institute of Electrical and Electronics Engineers (IEEE) 802.11) network may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via DL and UL. The DL (or forward link) may refer to the communication link from the AP to the station, and the UL (or reverse link) may refer to the communication link from the station to the AP.

In some examples, a wireless device (e.g., an AP or a STA) may perform rate matching (e.g., shortening, puncturing, or repetition) to transmit one or more encoded codewords over the air (OTA).

### SUMMARY

A method for wireless communication by a first wireless device is described. The method may include generating one or more low density parity check (LDPC) codewords based on performing LDPC encoding on data, each codeword of the one or more LDPC codewords including a respective set of data bits and a respective set of parity bits, adding one or more symbols or one or more symbol fractions to a first boundary of a packet to generate an adjusted first boundary, the first boundary specifying a first number of symbols of the packet allocated for the one or more LDPC codewords, where a puncturing ratio associated with the one or more LDPC codewords is reduced to a target value or set to zero, and transmitting, to a second wireless device, the packet including the one or more LDPC codewords that include a set of pre-forward error correction (FEC) padding bits based on the adjusted first boundary.

A first wireless device for wireless communication is described. The first wireless device may include one or more memories storing processor executable code, and one or more processors coupled with the one or more memories. The one or more processors may individually or collectively be operable to execute the code to cause the first wireless device to generate one or more LDPC codewords based on performing LDPC encoding on data, each codeword of the one or more LDPC codewords including a respective set of data bits and a respective set of parity bits, add one or more symbols or one or more symbol fractions to a first boundary of a packet to generate an adjusted first boundary, the first boundary specifying a first number of symbols of the packet allocated for the one or more LDPC codewords, where a puncturing ratio associated with the one or more LDPC codewords is reduced to a target value or set to zero, and transmit, to a second wireless device, the packet including the one or more LDPC codewords that include a set of pre-FEC padding bits based on the adjusted first boundary.

Another first wireless device for wireless communication is described. The first wireless device may include means for generating one or more LDPC codewords based on performing LDPC encoding on data, each codeword of the one or more LDPC codewords including a respective set of data bits and a respective set of parity bits, means for adding one or more symbols or one or more symbol fractions to a first boundary of a packet to generate an adjusted first boundary, the first boundary specifying a first number of symbols of the packet allocated for the one or more LDPC codewords, where a puncturing ratio associated with the one or more LDPC codewords is reduced to a target value or set to zero, and means for transmitting, to a second wireless device, the packet including the one or more LDPC codewords that include a set of pre-FEC padding bits based on the adjusted first boundary.

A non-transitory computer-readable medium storing code for wireless communication is described. The code may include instructions executable by one or more processors to generate one or more LDPC codewords based on performing LDPC encoding on data, each codeword of the one or more LDPC codewords including a respective set of data bits and a respective set of parity bits, add one or more symbols or one or more symbol fractions to a first boundary of a packet to generate an adjusted first boundary, the first boundary specifying a first number of symbols of the packet allocated for the one or more LDPC codewords, where a puncturing ratio associated with the one or more LDPC codewords is reduced to a target value or set to zero, and transmit, to a second wireless device, the packet including the one or more LDPC codewords that include a set of pre-FEC padding bits based on the adjusted first boundary.

Some examples of the method, first wireless devices, and non-transitory computer-readable medium described herein may further include operations, features, means, or instructions for identifying a physical layer coded bits boundary that specifies a second number of symbols of the packet allocated for the one or more LDPC codewords, where the first boundary includes a physical layer payload boundary, and where the physical layer coded bit boundary may be based on the adjusted first boundary.

Some examples of the method, first wireless devices, and non-transitory computer-readable medium described herein may further include operations, features, means, or instructions for mapping the one or more LDPC codewords to the second number of symbols of the packet and up to the physical layer coded bits boundary of the packet.

Some examples of the method, first wireless devices, and non-transitory computer-readable medium described herein may further include operations, features, means, or instructions for transmitting, to the second wireless device, signaling indicating the physical layer coded bits boundary or a parameter associated with the physical layer coded bits boundary.

In some examples of the method, first wireless devices, and non-transitory computer-readable medium described herein, the one or more LDPC codewords transmitted to the second wireless device include a nominal size of 648 bytes, 1296 bytes, 1944 bytes, or 3888 bytes that may be based on the physical layer coded bits boundary.

In some examples of the method, first wireless devices, and non-transitory computer-readable medium described herein, the one or more LDPC codewords transmitted to the second wireless device include the nominal size without shortening, puncturing, or repeating bits.

Some examples of the method, first wireless devices, and non-transitory computer-readable medium described herein may further include operations, features, means, or instructions for transmitting, to the second wireless device, signaling indicating one or both of the one or more symbols or the one or more symbol fractions added to the first boundary.

Some examples of the method, first wireless devices, and non-transitory computer-readable medium described herein may further include operations, features, means, or instructions for generating one or more second LDPC codewords based on performing the LDPC encoding on the data, each of the one or more second LDPC codewords including the respective set of data bits, a respective set of shortening bits, and the respective set of parity bits and discarding the respective sets of shortening bits, where generating the one or more LDPC codewords may be based on the one or more second LDPC codewords and on discarding the respective sets of shortening bits.

Some examples of the method, first wireless devices, and non-transitory computer-readable medium described herein may further include operations, features, means, or instructions for mapping the one or more LDPC codewords and the set of pre-FEC padding bits to the first number of symbols of the packet and up to the adjusted first boundary of the packet.

In some examples of the method, first wireless devices, and non-transitory computer-readable medium described herein, the packet further includes a packet extension that spans a fixed duration of 0 microseconds and the method, apparatuses, and non-transitory computer-readable medium may include further operations, features, means, or instructions for transmitting, to the second wireless device, signaling including an indication of the fixed duration of the packet extension.

In some examples of the method, first wireless devices, and non-transitory computer-readable medium described herein, the puncturing ratio associated with the one or more LDPC codewords may be reduced to the target value or set to zero based on a reduced puncturing associated with the adjusted first boundary compared to a puncturing associated with the first boundary.

In some examples of the method, first wireless devices, and non-transitory computer-readable medium described herein, the packet further includes a packet extension that spans a fixed duration.

In some examples of the method, first wireless devices, and non-transitory computer-readable medium described herein, a symbol fraction includes one or more symbol segments, each symbol segment spanning a fraction of a symbol, the fraction including ¼ of a symbol or ⅛ of a symbol.

A method for wireless communication by a first wireless device is described. The method may include generating one or more codewords based on performing LDPC encoding on data, each of the one or more codewords including at least a respective set of parity bits and a respective set of data bits, adjusting a physical layer coded bits boundary associated with the one or more codewords to be a value that corresponds to a last symbol fraction of a last symbol of one or more symbols of a data field of a packet, mapping the one or more codewords to at least one symbol fraction of the last symbol of the one or more symbols based on the adjusted physical layer coded bits boundary, and transmitting, to a second wireless device, the packet via the one or more symbols based on mapping the one or more codewords.

A first wireless device for wireless communication is described. The first wireless device may include one or more memories storing processor executable code, and one or more processors coupled with the one or more memories. The one or more processors may individually or collectively be operable to execute the code to cause the first wireless device to generate one or more codewords based on performing LDPC encoding on data, each of the one or more codewords including at least a respective set of parity bits and a respective set of data bits, adjust a physical layer coded bits boundary associated with the one or more codewords to be a value that corresponds to a last symbol fraction of a last symbol of one or more symbols of a data field of a packet, map the one or more codewords to at least one symbol fraction of the last symbol of the one or more symbols based on the adjusted physical layer coded bits boundary, and transmit, to a second wireless device, the packet via the one or more symbols based on mapping the one or more codewords.

Another first wireless device for wireless communication is described. The first wireless device may include means for generating one or more codewords based on performing LDPC encoding on data, each of the one or more codewords including at least a respective set of parity bits and a respective set of data bits, means for adjusting a physical layer coded bits boundary associated with the one or more codewords to be a value that corresponds to a last symbol fraction of a last symbol of one or more symbols of a data field of a packet, means for mapping the one or more codewords to at least one symbol fraction of the last symbol of the one or more symbols based on the adjusted physical layer coded bits boundary, and means for transmitting, to a second wireless device, the packet via the one or more symbols based on mapping the one or more codewords.

A non-transitory computer-readable medium storing code for wireless communication is described. The code may include instructions executable by one or more processors to generate one or more codewords based on performing LDPC encoding on data, each of the one or more codewords including at least a respective set of parity bits and a respective set of data bits, adjust a physical layer coded bits boundary associated with the one or more codewords to be a value that corresponds to a last symbol fraction of a last symbol of one or more symbols of a data field of a packet, map the one or more codewords to at least one symbol fraction of the last symbol of the one or more symbols based on the adjusted physical layer coded bits boundary, and transmit, to a second wireless device, the packet via the one or more symbols based on mapping the one or more codewords.

Some examples of the method, first wireless devices, and non-transitory computer-readable medium described herein may further include operations, features, means, or instructions for identifying a pre-FEC padding bit boundary associated with a set of pre-FEC padding bits, where generating the one or more codewords may be based on identifying a pre-FEC padding bit boundary, the one or more codewords including the set of pre-FEC padding bits.

Some examples of the method, first wireless devices, and non-transitory computer-readable medium described herein may further include operations, features, means, or instructions for transmitting, to the second wireless device, signaling including one or more of an indication of the pre-FEC padding bit boundary an indication of a parameter associated with the pre-FEC padding bit boundary, or an indication that a condition may have been satisfied.

Some examples of the method, first wireless devices, and non-transitory computer-readable medium described herein may further include operations, features, means, or instructions for performing rate matching on the one or more codewords, where the rate matching includes LDPC rate matching.

In some examples of the method, first wireless devices, and non-transitory computer-readable medium described herein, the packet includes a packet extension that spans a fixed duration of 0 microseconds and the method, apparatuses, and non-transitory computer-readable medium may include further operations, features, means, or instructions for transmitting, to the second wireless device, signaling including an indication of the fixed duration of the packet extension. In some examples of the method, first wireless devices, and non-transitory computer-readable medium described herein, the packet further includes a packet extension that spans a fixed duration.

### BRIEF DESCRIPTION OF THE DRAWINGS

FIG. 1 shows an example of a wireless local area network (WLAN) that supports techniques for low density parity check (LDPC) rate matching in accordance with aspects of the present disclosure.

FIG. 2 shows an example of a WLAN that supports techniques for LDPC rate matching in accordance with one or more aspects of the present disclosure.

FIG. 3 shows an example of a packet that supports techniques for LDPC rate matching in accordance with one or more aspects of the present disclosure.

FIG. 4 shows an example of a packet scheme that supports techniques for LDPC rate matching in accordance with one or more aspects of the present disclosure.

FIG. 5 shows an example of a process flow that supports techniques for LDPC rate matching in accordance with one or more aspects of the present disclosure.

FIGS. 6 and 7 show block diagrams of devices that support techniques for LDPC rate matching in accordance with one or more aspects of the present disclosure.

FIG. 8 shows a block diagram of a communications manager that supports techniques for LDPC rate matching in accordance with one or more aspects of the present disclosure.

FIG. 9 shows a diagram of a system including an AP that supports techniques for LDPC rate matching in accordance with one or more aspects of the present disclosure.

FIG. 10 shows a diagram of a system including a STA that supports techniques for LDPC rate matching in accordance with one or more aspects of the present disclosure.

FIGS. 11 through 14 show flowcharts illustrating methods that support techniques for LDPC rate matching in accordance with one or more aspects of the present disclosure.

### DETAILED DESCRIPTION

In some examples, a wireless device (e.g., an access point (AP) or a station (STA)) may perform rate matching (e.g., puncturing, repeating, or shortening) on low density parity check (LDPC) codewords in order to fit the LDPC codewords within a boundary (e.g., a physical layer coded bits boundary) of a packet. However, for short packet sizes, a puncturing ratio may be large. That is, a number of parity bits removed from the LDPC codewords during rate matching may exceed a threshold. With less parity bits (e.g., due to a large puncturing ratio), the receiver may be unable to detect and correct error in the data resulting in a decrease in reliability.

To increase reliability, the wireless device may adjust a first boundary (e.g., a physical layer payload boundary or a physical layer coded bits boundary) of the packet by adding one or more symbols or symbol fractions. For example, the wireless device may generate one or more LDPC codewords based on performing error correction encoding on data, add one or more symbols or one or more symbol fractions to the first boundary to adjust the physical layer payload boundary such that a puncturing ratio is reduced (e.g., set to a lower non-zero value when compared to other methods) or set to zero (e.g., may not implement puncturing), and transmit the packet in accordance to the adjusted physical layer payload boundary.

As another example, the wireless device may generate one or more LDPC codewords based on performing error correction encoding on data, adjust a physical layer coded bits boundary to be a value corresponding to a last symbol segment of a last symbol of the packet, map the one or more codewords to at least one symbol segment of the last symbol, and transmit the packet in accordance to the adjusted physical layer coded bits boundary. Using the methods as described herein may allow the wireless device to lower a puncturing ratio (e.g., reduce a puncturing ratio to a target value or may not implement puncturing) of small package sizes when compared to other methods which may increase the reliability of the data.

Aspects of the disclosure are initially described in the context of a wireless communications system. Additional aspects are described in the context of packets, packet schemes, and process flows. Aspects of the disclosure are further illustrated by and described with reference to apparatus diagrams, system diagrams, and flowcharts that relate to techniques for LDPC rate matching.

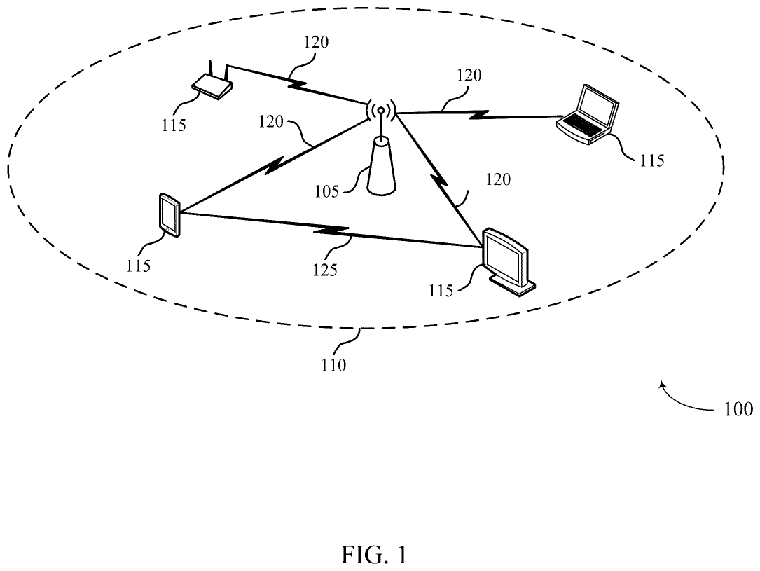

FIG. 1 shows a wireless local area network (WLAN) 100 (also known as a Wi-Fi network) configured in accordance with various aspects of the present disclosure. The WLAN 100 may include an AP 105 and multiple associated STAs 115, which may represent devices such as mobile stations, personal digital assistant (PDAs), other handheld devices, netbooks, notebook computers, tablet computers, laptops, display devices (e.g., TVs, computer monitors, etc.), printers, etc. The AP 105 and the associated stations 115 may represent a BSS or an ESS. The various STAs 115 in the network are able to communicate with one another through the AP 105. Also shown is a coverage area 110 of the AP 105, which may represent a BSA of the WLAN 100. An extended network station (not shown) associated with the WLAN 100 may be connected to a wired or wireless distribution system that may allow multiple APs 105 to be connected in an ESS.

As described herein, a device (e.g., the AP 105 or the STA 115) may reduce a puncturing ratio of transmitted encoded codewords using one or more methods. As a first method, the device may generate one or more LDPC codewords and add one or more symbols or one or more symbol fractions to adjust a first boundary of a packet such that a puncturing ratio associated with the one or more LDPC codewords is reduced (e.g., set to a non-zero target value) or set to zero (e.g., may not implement puncturing). In some examples, the first boundary may specify a first number of symbols of the packet allocated for the one or more LDPC codewords. Further, the device may transmit the packet including the one or more LDPC codewords that includes a set of pre-forward error correction (FEC) padding bits to a second device based on the adjusted first boundary.

As a second method, the device may generate one or more codewords and adjust a physical layer coded bits boundary associated with the one or more codewords to be a value that corresponds to a last symbol fraction of a last symbol of one or more symbols of a data field of a packet. Further, the device may map the one or more codewords to at least one symbol fraction of the last symbol of the one or more symbols and transmit the packet to a second device via the one or more symbols.

Although not shown in FIG. 1, a STA 115 may be located in the intersection of more than one coverage area 110 and may associate with more than one AP 105. A single AP 105 and an associated set of STAs 115 may be referred to as a BSS. An ESS is a set of connected BSSs. A distribution system (not shown) may be used to connect APs 105 in an ESS. In some cases, the coverage area 110 of an AP 105 may be divided into sectors (also not shown). The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN 100.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., CSMA/CA) because the STAs 115 may not refrain from transmitting on top of each other. A STA 115 whose transmissions are not identifiable, but that is within the same coverage area 110 may be known as a hidden node. CSMA/CA may be supplemented by the exchange of an RTS packet transmitted by a sending STA 115 (or AP 105) and a CTS packet transmitted by the receiving STA 115 (or AP 105). This may alert other devices within range of the sender and receiver not to transmit for the duration of the primary transmission. Thus, RTS/CTS may help mitigate a hidden node problem.

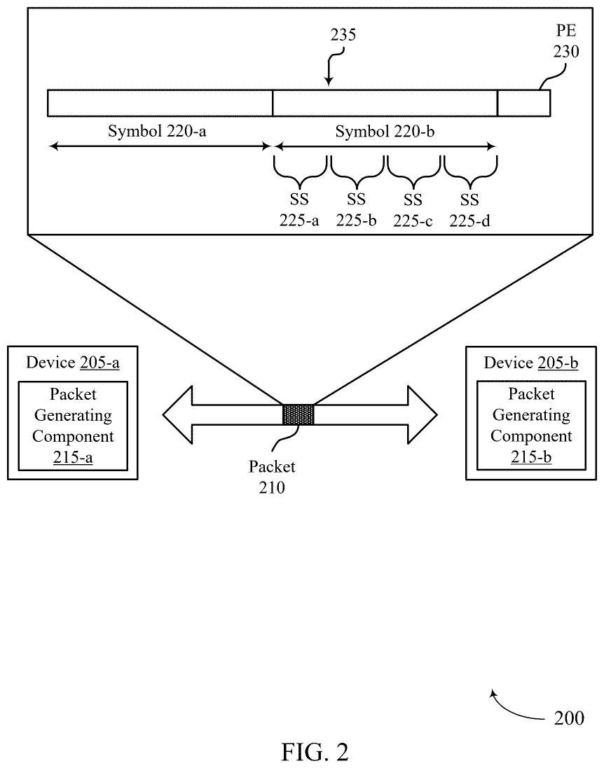

FIG. 2 shows an example of a WLAN 200 that supports techniques for LDPC rate matching in accordance with one or more aspects of the present disclosure. In some examples, the WLAN 200 may implement aspects of the WLAN 100. For example, the WLAN 200 may include devices 205 which may be examples of STAs 115 or APs 105 as described with reference to FIG. 1.

In some examples, the device 205-a may communicate data with the device 205-b. For example, the device 205-a may transmit a packet 210 containing the data to the device 205-b or vice versa. To generate the packet 210, the devices 205 may implement a respective packet generating component 215 (e.g., a packet generating component 215-a or a packet generating component 215-b). The packet generating component 215 may perform multiple functions to generate the packet 210. For example, the packet generating component 215 may perform error correction encoding on the data. Error correction encoding may enable a receiving device (e.g., the device 205-b) to identify and potentially correct any errors in the data sent from the transmitting device (e.g., the device 205-a).

As an example of error correction encoding, the packet generating component 215 may perform LDPC encoding on the data. LDPC may be described as a linear error correcting code that has a fixed size. During LDPC encoding, the packet generating component 215 may input a set of data bits into an LDPC encoder and the LDPC encoder may output an LDPC codeword that includes the set of data bits and a set of parity bits. However, in some cases, a length of a physical layer service data unit (PSDU) within the packet 210 may not be an integer multiple of a length of the LDPC codeword. Thus, the packet generating component 215 may perform rate matching to fit the LDPC codewords in the PSDU. In some systems, the length of the PSDU may be indicated in a high throughput signaling field (e.g., HT-SIG) or may be implicitly indicated by a combination of a few parameters, including a length subfield of a legacy signaling field (e.g., L-SIG). Further, due to the rate matching, an effective code rate may vary with the PSDU length.

Examples of rate matching may include shortening, puncturing, or repeating. If the PSDU length cannot be evenly divided into an integer number of sets of data bits such that a size of each set of data bits is equal to an input size of the LDPC encoder to generate one codeword, the packet generating component 215 may append a set of shortening bits (e.g., a series of 0s) to the set of data bits and input the set of shortening bits and the set of data bits into the LDPC encoder. The set of shortening bits may than be removed at the output resulting in an LDPC codeword that includes the set of parity bits and the set of data bits. Puncturing may refer to the removal of at least a subset of the set of parity bits from the LDPC codeword resulting in a shorter LDPC codeword and repeating may refer to appending a repetition of at least a subset of the set of data bits to the LDPC codeword resulting in a longer LDPC codeword.

In some examples, the rate-matched LDPC codewords may make up a first portion of the packet 210 up until a boundary (e.g., a physical layer coded bits boundary). For example, the rate-matched LDPC codewords may fill up the packet 210 until the boundary 235 (e.g., the physical layer coded bits boundary) and occupy the symbol 220-a as well a symbol segment 225-a of the symbol 220-b of the packet 210. In some examples, the packet generating component 215 may implement pre-FEC padding. That is, the packet generating component 215 may pad the set of data bits with a set of random bits (e.g., pre-FEC padding bits) prior to LDPC encoding. As such, the LDPC codewords may also include a set of pre-FEC padding bits. In some examples, the packet generating component 215 may determine a pre-FEC padding bits boundary. It is defined according to a ratio of the number of physical layer payload bits which includes pre-FEC padding bits, over the number of data bits carried in one OFDM symbol. The integer portion of this ratio is a certain number of OFDM symbols (e.g., (N_{SYM,init}−1) if aᵢₙᵢₜ<4 and N_{SYM,init} if aᵢₙᵢₜ=4 for LDPC encoding in 802.11ax and 802.11be. The fractional portion of this ratio takes certain discrete values of zero to three symbol segments in 802.11ax and 802.11be, as one OFDM symbol is divided into 4 symbol segments. In 802.11ax and 802.11be specification, it is usually described as (N_{SYM,init}−1) OFDM symbols plus aᵢₙᵢₜ symbol segments (i.e., one to four symbol segments), where four symbol segments is essentially one OFDM symbol. The pre-FEC padding bits boundary may be in a last symbol 220 of the packet 210 and may be a fractional of the last OFDM symbol 220 (e.g., ¼, ½, ¾, or 1 of a symbol 220) of the packet 210. In some examples, the packet generating component 215 may determine a value of the pre-FEC padding bits boundary (e.g., a_init) based on a pre-FEC padding factor (e.g., a) and a number of symbols (e.g., N_sym_init). The pre-FEC padding factor may be equal to one, two, three, or four if one symbol 220 is divided into four symbol segments as in 802.11ax and 8-2.11be. In the example of FIG. 2, the pre-FEC padding factor may be equal to one and as such, the pre-FEC padding bits boundary may be equal to the boundary 235 or ¼ of the symbol 220-b. Initially, the physical layer coded bits boundary may be equal to the pre-FEC padding bits boundary. However, the physical layer coded bits boundary may change resulting in partial LDPC codewords extending past the pre-FEC padding bits boundary.

In some examples, the packet generating component 215 may also allocate an extra symbol segment 225 of the symbol 220-b to the LDPC codewords. For example, the packet generating component 215 may further allocate the symbol segment 225-b or another symbol segment 225 of the symbol 220-b (e.g., the symbol segment 225-c or the symbol segment 225-d) to the LDPC codewords. In some examples, the packet generating component 215 may allocate the extra symbol segment 225 based on a condition being satisfied. For example, the packet generating component 215 may allocate the extra symbol segment 225 in response to a puncturing ratio exceeding a threshold, or a puncturing ratio exceeding another threshold while at the same time the puncturing ratio divided by the shortening ratio is greater than yet another threshold. In some examples, the packet generating component 215 may determine the physical layer coded bits boundary and the pre-FEC padding bits boundary based on whether the extra symbol segment is added or not. In some examples, the packet generating component 215 may determine the physical layer coded bits boundary based on whether the extra symbol segment is added or not, while the pre-FEC padding bits boundary may not depend on whether the extra symbol segment is added or not. For example, the physical layer coded bits boundary may extend past the pre-FEC padding bits boundary if an extra symbol segment is added.

Further, the packet generating component 215 may implement post-FEC padding. In some examples, post-FEC padding bits may make a second portion of the packet 210. For example, the post-FEC padding bits may occupy symbol segments 225 between the physical layer coded bits boundary and the end of the symbol 220-b. After the symbol 220-b, the packet 210 may include a packet extension 230. The packet extension 230 may be described as a field with a duration of 0 us, 4 us, 8 us, 12 us, and 16 us and may provide extra receiver processing time. In some examples, the duration of the packet extension 230 may depend on a length of the post-FEC padding bits or the physical layer coded bits boundary. For example, the duration of the packet extension 230 may decrease as the length of the post-FEC padding bits increase.

As shown in FIG. 2, the WLAN 200 may support small packet sizes (e.g., less than 1 kilobyte). Due to the small packet size, the puncturing ratio may be relatively large, even with the addition of the extra symbol segment. For example, the packet generating component 215 may puncture hundreds of bits and the addition of the extra symbol segment may only allow for the recovery of a very small portion of the punctured bits (e.g., 20 bits) which may not affect the puncturing ratio. A high puncturing ratio may decrease the reliability of the data because an LDPC decoder at the receiver may be unable to detect or correct errors using only a small amount of parity bits. In the various embodiments described herein, a physical preamble may indicate a quantity of extra symbols (e.g., OFDM symbols), a quantity of extra symbol segments (e.g., quantity of fractions of symbols) for small resource units (RU), extended long range (ELR) transmission, or both, to reduce the puncturing ratio, and, in some examples, such information may be signaled in a user info field.

As described herein, the packet generating component 215 may implement a rate matching scheme that has a lower puncturing ratio and a lower code rate when compared to other methods. A lower code rate may lead to lower receiver sensitivity (e.g., lower SNR) and a lower puncturing ratio may lead to better LDPC decoder performance. As a first option, the packet generating component 215 may not implement shortening, puncturing, or repetition. Alternatively, the size of the LDPC codewords in transmission may be equal to their nominal sizes. First, the packet generating component 215 may determine the boundaries of the physical layer coded bits using the size of PSDU and the pre-FEC padding factor. In the example of FIG. 2, the packet generating component may determine that the boundaries of the physical layer coded bits may be the start of the symbol 220-a to the boundary 235 (or the physical layer coded bits boundary).

Second, the packet generating component 215 may determine a number of LDPC codewords that may fit into the packet 210 up until the physical layer coded bits boundary (e.g., the boundary 235). Third, the packet generating component 215 may determine a pre-FEC padding size based on the determined number of LDPC codewords. Fourth, the packet generating component 215 may perform post-FEC padding after the end of the physical layer coded bits boundary until the end of the last symbol of the packet 210 (e.g., the symbol 220-b). In some examples, the transmitting device (e.g., the device 205-a) may signal the pre-FEC padding factor to the receiving device (e.g., the device 205-b) in a preamble of the packet 210.

As a second option, the packet generating component 215 may implement shortening as in 802.11ax and 802.11be, but may not implement puncturing or repetition. Instead, the packet generating components 215 may fill the packet 210 with at least a portion of the LDPC codewords from the start of the symbol 220-a until the physical layer coded bits boundary (e.g., the boundary 235) and fill one or more extra symbol segments 225 of the symbol 220-b or extra symbols 220 with any remaining LDPC codewords or LDPC codeword portions. Further, any remaining symbol segments 225 not occupied by physical layer coded bits may be filled with the post-FEC padding bits.

Additionally, or alternatively, as a third option, the packet generating component 215 may implement shortening as in 802.11ax and 802.11be, but may not implement post-FEC padding. Instead, the packet generating component 215 may allocate one or more symbols 220 (e.g., at least the symbol 220-b) following the physical layer coded bits boundary (e.g., the boundary 235) to LDPC codewords. In some examples, the packet generating component 215 may perform rate matching through puncturing or repetition on the LDPC codeword to fit the size. In some examples, a puncturing ratio may be set to 0 (e.g., “may not implement puncturing”) or the puncturing ratio may be reduced to a target value (e.g., from a first non-zero value to a second non-zero value). In such examples, if the puncturing ratio may be reduced to a target value (e.g., from a first non-zero value to a second non-zero value), the packet generating component 215 may still perform puncturing, and may further perform repetition. In another example, reducing a puncturing ratio may involve setting the second non-zero value (e.g., the target value) of the puncturing ratio to be 10% or 20% (or other percentage less than 100%) of a first non-zero value (e.g., an original value of the puncturing ratio) of the puncturing ratio. In some examples, a puncturing value may be reduced by reducing a quantity of puncturing bits.

The Table 1 illustrates the three different options and the potential differences between the options. The different options may be associated with different schemes, including schemes 0, 1, 2.0, and 2.1.

TABLE 1

| | Effective | | Pre-FEC | Physical layer | Post-FEC |
|---|---|---|---|---|---|
| | Code | Puncturing | Padding | coded bits | Padding |
| Option | Rate | Ratio | Boundary | boundary | Bits |
| 0 | Nominal Code | 0 | Same as | Add extra | Remaining |
| (Scheme 0) | Rate | | physical | symbols/symbol | of the |
| | | | layer coded | segments. No | last |
| | | | bits | shortening, | symbol. |
| | | | boundary. | puncturing, or | |
| | | | | repeating. | |
| 1 | Determined | 0 | Determined | Add extra | Remaining |
| (Scheme 1) | based on a | | based on | symbols/symbol | of the |
| | length of the | | pre-FEC | segments. No | last |
| | physical layer | | padding | puncturing or | symbol. |
| | coded bits | | Factor and | repeating. | |
| | | | LDPC extra | | |
| | | | symbol segment | | |
| 2 | Determined | Determined | Determined | Add extra | None. |
| (Scheme | based on the | based on the | based on | symbol segment | |
| 2.0 and | length of the | physical | pre-FEC | and force pre- | |
| 2.1) | physical layer | layer coded | padding | FEC padding | |
| | coded bits | bits boundary | Factor and | factor to | |
| | | and a length | LDPC extra | equal 4. | |
| | | of the | symbol segment | | |
| | | physical | | | |
| | | layer coded | | | |
| | | bits. | | | |

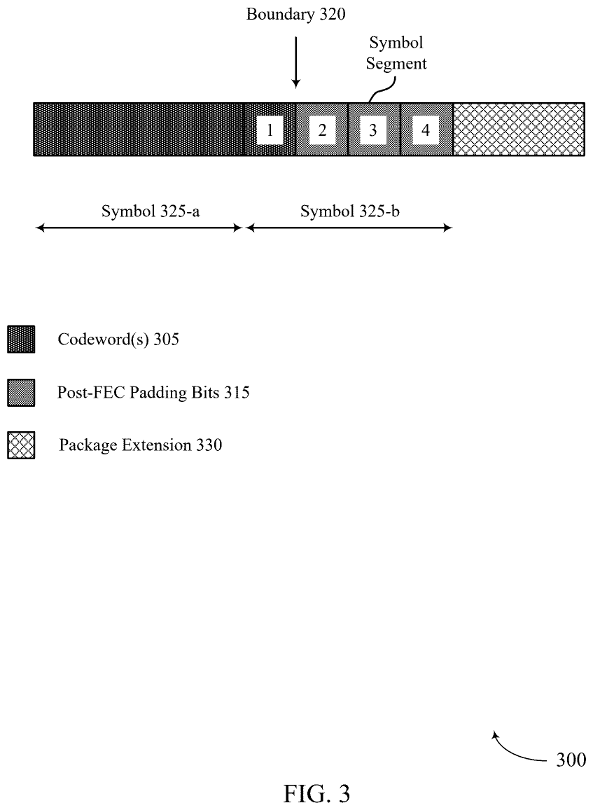

FIG. 3 shows an example of a packet 300 that supports techniques for LDPC rate matching in accordance with one or more aspects of the present disclosure. In some examples, the packet 300 may be implemented by aspects of the WLAN 100 and the WLAN 200. For example, the packet 300 may be implemented by an AP 105 or a STA 115 as described with reference to FIG. 1. Further, the packet 300 may be implemented by devices 205 as described with reference to FIG. 2.

As described with reference to FIG. 2, a first device may transmit a packet 300 to a second device. In some examples, the packet 300 may occupy at least a symbol 325-a and a symbol 325-b. Using a first method, the first device may determine a boundary 320 (e.g., a physical layer coded bits boundary) for the packet 300. The boundary 320 may specify a number of symbols and/or symbol segments within the packet 300 that a set of physical layer coded bits (e.g., LDPC codewords which may include data bits, parity bits, and pre-FEC padding bits) may occupy or be mapped to. To determine the boundary 320, the first device may utilize a PSDU length and a pre-FEC padding factor (e.g., a). The first device may obtain the PSDU length (e.g., a number of symbols or a number of bytes) from L-SIG or HT-SIG. In the example of FIG. 2, the first device may determine the boundary 320 may be located at a ¼ mark of the symbol 325-b or at the end of the first symbol segment of the symbol 325-b.

After determining the boundary 320, the first device may perform multiple steps to determine an integer number of nominally sized codewords 305 that may fit within the boundary 320 of the packet 300. As a first step, the first device may determine a set of candidate codewords of nominal size. For example, the set of candidate codeword may include codewords of size 648 bytes, 1296 bytes, 1944 bytes, or 3888 bytes. Next, the first device may determine a minimum number of codewords for each candidate codeword size based on a payload size prior to adding pre-FEC padding. Further, the first device may determine a minimum number of coded bits according to this payload size and the nominal code rate for each candidate codeword size. Then, the first device may calculate a number of symbols for each candidate codeword size as well as a number of symbol segments in the last OFDM symbol for each size and a corresponding maximum number of coded bits in the symbol segments based on the maximum number of codewords that fit in the number of symbols and number of symbol segments in the last OFDM symbol for each codeword size.

After this, the first device may calculate the maximum number of coded bits for each candidate codeword size based on the boundary 320 and determine a number of codewords for each candidate codeword size based on the maximum number of coded bits. Following this, the first device may select the codeword size. That is, the first device may determine a quantity of codewords of a certain size (e.g., candidate nominal size) that fits within the boundary 320. In the example of FIG. 2, the first device may determine a quantity of nominally sized codewords that span from the beginning of the symbol 325-a to a portion of the first symbol segment (or symbol segment 1) of the symbol 325-b.

After determining the quantity of codewords, the first device may calculate a pre-FEC padding size. In some examples, the pre-FEC padding bits may fill any remaining bits in the first symbol segment of the last symbol up until the pre-FEC padding bit boundary. For example, the pre-FEC padding bits may fill the remaining portion of the first symbol segment up until the boundary 320. After determining the quantity of codewords and the pre-FEC padding bit size, the first device may perform LDPC encoding in accordance with the above calculations. Thus, the number of physical layer coded bits may be equal to an integer number of codewords multiplied by the nominal codeword length.

Further, the first device may determine a post-FEC padding size. In some examples, the first device may fill the remaining symbol segments of the last symbol 325 of the packet 300 with post-FEC padding bits 315. For example, as shown in FIG. 2, the post-FEC padding bits 315 may span from the boundary 320 to the end of the symbol 325-b of the packet 300. In some examples, the packet 300 may also include a packet extension 330 that follows the symbol 325-b. Unlike other methods, a duration of the packet extension 330 may not depend on the boundary 320 or the post-FEC padding size and may take values within a nominal set of values of 0 us, 4 us, 8 us, 12 us, and 16 us. The choice of the nominal value of the packet extension 330 may be signaled in a physical preamble of the packet 300. Instead, the packet extension 330 may be a fixed value (e.g., 16 us). Therefore, when compared to other methods, a package extension disambiguity bit may be removed from a physical preamble of the packet 300.

Once the packet 300 is generated, the first device may transmit the packet 300 to the second device. Upon receiving the packet 300, the second device may undergo similar steps as described above to process the packet 300. For example, the second device may determine a set of candidate codewords of nominal size. Further, the second device may calculate a maximum number of coded bits in a last symbol of the packet 300 for each candidate codeword size based on the pre-FEC padding factor (e.g., indicated in the physical preamble of the packet 300). Following this, the second device may calculate the maximum number of coded bits based on the maximum number of coded bits in the last symbol and the pre-FEC padding factor. Further, the second device may determine a number of codewords for each codeword size based on the maximum number of coded bits. Lastly, the second wireless device may select the codeword size. That is, the first device may determine a quantity of codeword of a certain size that fits within the boundary 320. Using this information, the second device may process the packet 300. In some examples, in order to utilize the above method, one or more rules for determining the codeword size may be modified compared to other methods.

In another example, the first device may adjust the boundary 320 (e.g., the physical layer coded bits boundary) by adding one or more symbols or one or more symbol segments such that more physical layer coded bits can fit into the packet 300. In such examples, the first device may perform LDPC encoding on data to generate one or more codewords 305. Performing LDPC encoding on the data may include inputting data bits as well as shortening bits (of 0 values) into an LDPC encoder. The LDPC encoder may output the systematic bits which is the combination of the data bits and shortening bits and parity bits corresponding to the systematic bits. Because the shortening bits are of known value and may not be useful, the first device may remove the shortening bits resulting in one or more codewords each including a respective set of data bits and a respective set of parity bits.

After generating the one or more codewords 305, the first device may determine a number of symbols or symbol segments to adjust the boundary 320. In some examples, the first device may determine a length of the one or more generated codewords is one symbol plus two symbol segments. In such examples, the first device may adjust the boundary 320 to be at the end of the second symbol segment (or ½) of the symbol 325-b. In another example, the length of the one or more codewords may occupy two symbols. In such examples, the first device may add a symbol 325 onto the last symbol 325 (e.g., the symbol 325-b) of the packet 300 and adjust the boundary 320 by one symbol. In some examples, the first device may signal the number of extra symbols or symbols segments (e.g., fractions of a symbol) to the second device (e.g., in a physical preamble of the packet 300) such that the second device may process the packet 300.

Using the methods as described herein, the first device may transmit one or more codewords to the second device without performing puncturing or repetition. In this way, the one or more codewords 305 may retain all of the parity bits generated during LDPC encoding which may increase the reliability of the data.

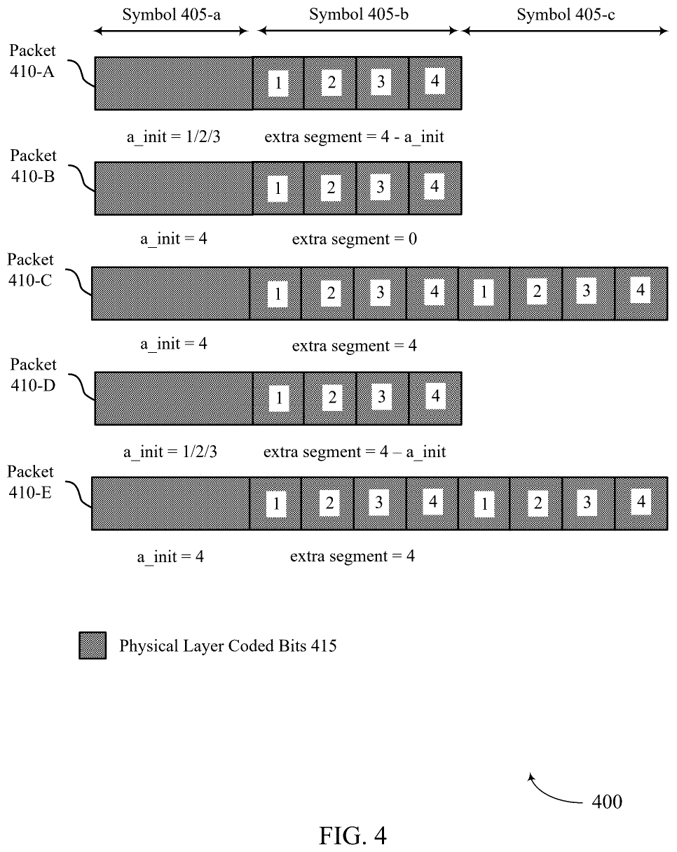

FIG. 4 shows an example of a packet scheme 400 that supports techniques for LDPC rate matching in accordance with one or more aspects of the present disclosure. In some examples, the packet scheme 400 may be implemented by aspects of the WLAN 100 or the WLAN 200. For example, the packet scheme 400 may be implemented by an AP 105 or a STA 115 as described with reference to FIG. 1. Further the packet 300 may be implemented by devices 205 as described with reference to FIG. 2.

As described with reference to FIG. 2, a first device may transmit a packet 410 to a second device. To generate the packet 410, the first device may perform error correction encoding (e.g., LDPC encoding) on data. That is, the first device may input the data as well as padding bits (e.g., pre-FEC padding bits) into an error correction encoder and the error correction encoder may output one or more codewords (e.g., data bits and corresponding parity bits). In some examples, the output of the error correction encoder (e.g., the one or more codewords) may be known as physical layer coded bits 415.

In some examples, the first device may fit the physical layer coded bits 415 into the packet 410 up until a physical layer coded bits boundary. The first device may determine the physical layer coded bits boundary based one or more parameters. For example, the first device may determine the physical layer coded bits boundary based at least in part on a pre-FEC padding boundary (e.g., a_init) or a parameter associated with the pre-FEC padding boundary (e.g., a). Further, in some examples, the first device may conditionally adjust the physical layer coded bits boundary of the packet 410 such that the physical layer coded bits boundary is located at end of a last data OFDM symbol 405 of the packet 410.

In some examples, prior to determining the physical layer coded bits boundary, a value of one may indicate that the pre-FEC padding boundary is located at an end of a first symbol segment (or symbol segment 1) of the symbol 405-b. The initial physical layer coded bits boundary is the same as the pre-FEC padding boundary. Further, the first device may determine whether a condition is satisfied. If the condition is satisfied, the first device may adjust the physical layer coded bits boundary by firstly adding one extra symbol segment, and then further adding the remaining number of the symbol segments in the last OFDM symbol such that the physical layer coded bits boundary is located at an end of the last symbol 405-b of the packet 410-a (or the last symbol fraction of the symbol 405-b). That is, the first device may add a number of extra symbol segments to adjust the physical layer coded bits boundary. Alternatively, if the condition is not satisfied, the first device may adjust the physical layer coded bits boundary by just adding the remaining number of symbol segments in the last OFDM symbol.

For example, the first device may generate the packet 410-a. To generate the packet 410-a, the first device may generate the physical layer coded bits 415 and determine a physical layer coded bits boundary for the physical layer coded bits 415. The first device may identify the pre-FEC padding boundary which may include a value of one, two, or three. The number of extra symbol segments may depend on the pre-FEC padding bits boundary. For example, the first device may subtract a total number of symbol segments of the symbol 405-b (e.g., 4 symbol segments) by the pre-FEC padding bit boundary to determine the number of extra symbols segments. As one example, the pre-FEC padding bit boundary may be equal to one. In such examples, the first device may add three extra symbol segments to the physical layer coded bits boundary such that the physical layer coded bits boundary is located at the end of the symbol 405-b. After determining the physical layer coded bits boundary, the first device may map the physical layer coded bits to the symbol 405-a and the symbol 405-b.

In another example, the first device may generate a packet 410-b. Unlike the example described with reference to the packet 410-a, the pre-FEC padding bit boundary may be equal to a value of four and as such, the pre-FEC coding bit boundary may be located at the end of the fourth symbol segment (or symbol segment 4) of the symbol 405-b. In such examples, if the first device determines that the condition is not satisfied, the first device may not adjust the physical layer coded bits boundary because the adjusted physical layer coded bits boundary may be equal to the pre-FEC padding bit boundary. Thus, the first device may map the physical layer coded bits to the symbol 405-a and the symbol 405-b of the packet 410-b. Alternatively, as shown with the packet 410-c, if the first device determines that the condition is satisfied, the first device may adjust the physical layer coded bits boundary by firstly adding one extra symbol segment and reaching the first symbol segment (segment 1) of the next OFDM symbol and then further adding the remaining number of the symbol segments in the last OFDM symbol, which essentially is equivalent to adding an extra symbol 405-c which includes four extra symbol segments. Thus, the first device may map the physical layer coded bits to the symbol 405-a, the symbol 405-b, and the symbol 405-c of the packet 410-c.

In other examples, the first device may not determine whether the condition is satisfied and based on the initial physical layer coded bits boundary (which is the same as the pre-FEC padding boundary), it may always firstly add one extra symbol segment and then further add the remaining number of symbol segments in the last OFDM symbol to adjust the physical layer coded bits boundary such that the physical layer coded bits boundary is located at the end of the last symbol 405 of the packet 410. For example, parameters for the packet 410-a and the packet 410-d may be similar. That is, the pre-FEC padding bit boundary may be equal to one, two, or three. However, unlike the scheme discussed with respect to packet 410-a, the first device may not adjust the physical layer coded bits boundary of the packet 410-d based on the condition being satisfied. Instead, whether or not the condition is satisfied, the first device may add a number of extra symbol segments to the physical layer coded bits boundary of the packet 410-d.

The number of extra symbol segments may depend on the pre-FEC padding bits boundary. For example, the first device may subtract a total number of symbol segments of the symbol 405-b (e.g., 4 symbol segments) by the pre-FEC padding bit boundary to determine the number of extra symbols segments. As one example, the pre-FEC padding bit boundary may be equal to one. In such examples, the first device may add three extra symbol segments to the physical layer coded bits boundary such that the physical layer coded bits boundary is located at the end of the symbol 405-b. After determining the physical layer coded bits boundary, the first device may map the physical layer coded bits to the symbol 405-a and the symbol 405-b of the packet 410-d.

Additionally, parameters for the packet 410-e, the packet 410-b, and the packet 410-c may be similar. That is, the pre-FEC padding bit boundary of the packet 410-c may be equal to four. However, unlike the scheme discussed with respect to packet 410-c and the packet 410-c, the first device may not adjust the physical layer coded bits boundary of the packet 410-e based on the condition being satisfied. Instead, whether or not the condition is satisfied, the first device may adjust the physical layer coded bits boundary by adding an extra symbol 405-c which includes four extra symbol segments. Thus, the first device may map the physical layer coded bits to the symbol 405-a, the symbol 405-b, and the symbol 405-c of the packet 410-c.

Further, in some examples, to fit the physical layer coded bits 415 within the physical layer coded bits boundary of the packets 410 (e.g., the packet 410-a, the packet 410-b, the packet 410-c, the packet 410-d, and the packet 410-e), the first device may perform rate matching (e.g., shortening, puncturing, or repetition). Additionally, the packets 410 may not include post-FEC padding bits. That is, the first device may refrain from generating post-FEC padding bits when operating according to the schemes presented in FIG. 4. In some examples, to implement the options described in FIG. 4, the first device may transmit signaling to the second device indicating one or more of the pre-FEC padding bit boundary, a parameter associated with the pre-FEC padding bit boundary, or the number of extra symbol segments added to the physical layer coded bits boundary. Using the method as described herein may decrease a puncturing ratio (e.g., from a first non-zero value to a second non-zero value or a zero value) of the physical layer coded bits and decrease an effective coding rate when compared to other methods.

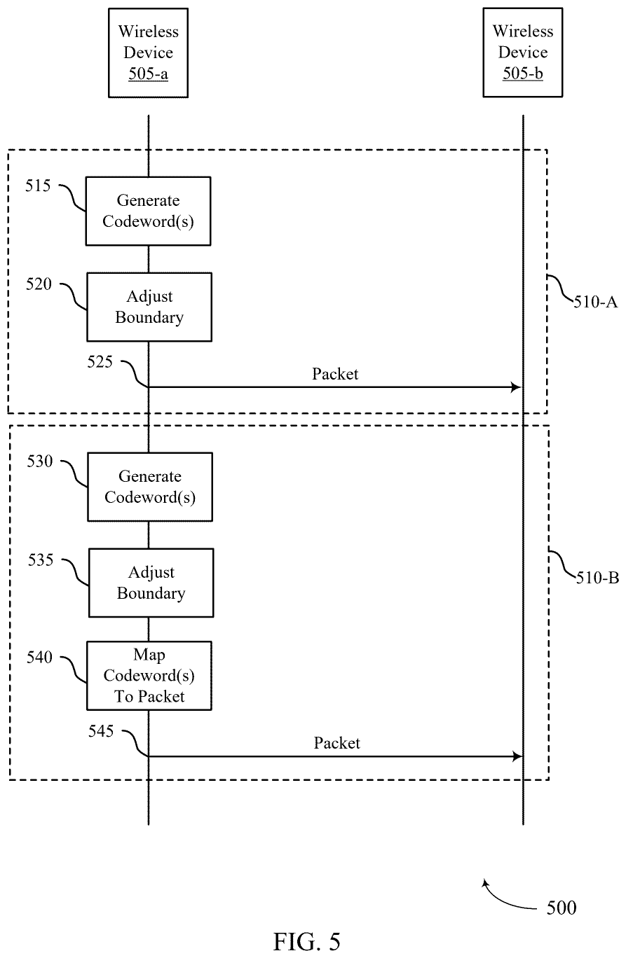

FIG. 5 shows an example of a process flow 500 that supports techniques for LDPC rate matching in accordance with one or more aspects of the present disclosure. In some examples, the process flow 500 may be implemented by aspects of the WLAN 100 or the WLAN 200. For example, the process flow 500 may be implemented by wireless devices 505 which may be examples of an AP 105 or a STA 115 as described with reference to FIG. 1. Further, the wireless device may be examples of devices 205 as described with reference to FIG. 2. Alternative examples of the following may be implemented, where some steps are performed in a different order then described or are not performed at all. In some cases, steps may include additional features not mentioned below, or further steps may be added.

In some examples, the wireless devices 505 may operate according to a scheme 510-a. For example, at 515, the wireless device 505-a may generate one or more LDPC codewords based on performing error correction encoding on data. In some examples, each LDPC codeword of the one or more LDPC codewords may include a respective set of data bits and a respective set of parity bits.

At 520, the wireless device 505-a may add one or more symbols or one or more symbol fractions to adjust a first boundary of a packet that specifies a first number of symbols of the packet allocated for the one or more LDPC codewords. In some examples, the wireless device 505-a may adjust the first boundary such that a puncturing ratio associated with the one or more LDPC codeword is reduced (e.g., to a target value) or set to zero (e.g., may not implement puncturing). In some examples, a symbol fraction may include one or more symbol segments and each symbol segment may represent a fraction of the symbol (e.g., ¼ of a symbol or ⅛ of a symbol).

In one example, adjusting the first boundary may include adjusting a physical layer payload boundary of the packet. In such examples, the wireless device 505-a may identify a physical layer coded bits boundary that specifies a second number of symbols of the packet allocated for the one or more LDPC codewords. The first device may map the one or more LDPC codewords to the second number of symbols of the packet specified by the physical layer coded bits boundary.

In another example, adjusting the first boundary may include adjusting the physical layer coded bits boundary or a boundary that corresponds to the one or more LDPC codewords. That is, the wireless device 505-a may add one or more symbols or symbol fractions to the physical layer coded bits boundary. In such examples, the first device may perform shortening prior to generating the one or more LDPC codewords.

To perform shortening, the wireless device 505-a may generate one or more second LDPC codewords based on performing the error correction encoding on the data and each of the one or more second LDPC codewords may include the respective set of data bits, the respective set of parity bits, and the respective set of shortening bits. Further, the wireless device 505-a may discard the respective sets of shortening bits to generate the one or more codewords. In addition, the wireless device 505-a may map the one or more LDPC codewords to the first number of symbols as indicated by the adjusted physical layer coded bits boundary.

At 525, the wireless device 505-a may transmit the packet to the wireless device 505-b according to the adjusted first boundary. The packet may include at least the one or more LDPC codewords that include the set of pre-FEC padding bits. Additionally, or alternatively, the packet may include a packet extension that spans a fixed duration (e.g., 0 microseconds, 4 microseconds, 8 microseconds, or 16 microseconds). Additionally, or alternatively, the packet or other signaling may include an indication of the one or more symbols or the one or more symbol fractions that the boundary was adjusted by or an indication of the fixed duration of the packet extension.

In other examples, the wireless device 505 may operate according to a scheme 510-b. For example, at 530, the wireless device 505-a may generate one or more codewords based on performing error correction encoding on data and each of the one or more codewords may include a respective set of parity bits and a respective set of data bits. Further, in some examples, the wireless device 505 may generate a set of pre-FEC padding bits based on performing the error correction encoding on the data.

At 535, the wireless device 505-a may adjust a physical layer coded bits boundary associated with the one or more codewords to be a value that corresponds to a last symbol fraction of a last symbol of one or more symbols of the packet. In some examples, a symbol fraction may include one or more symbol segments and each symbol segment may represent a fraction of the symbol (e.g., ¼ of a symbol or ⅛ of a symbol).

In some examples, prior to adjusting the physical layer coded bits boundary, the wireless device 505-a may identify a pre-FEC padding bit boundary associated with a set of pre-FEC padding bits and utilize aspects of the pre-FEC padding bit boundary to adjust the physical layer coded bits boundary. Additionally, or alternatively, prior to adjusting the physical layer coded bits boundary, the wireless device 505-a may determine that a condition is satisfied. In some examples, the condition may include a puncturing ratio associated with the one or more codewords being above a threshold.

In some examples, after adjusting the physical layer coded bits boundary, the wireless device 505-a may refrain from generating a set of post-FEC padding bits and as such, the packet may not include the set of post-FEC padding bits. Additionally, or alternatively, after adjusting the physical layer coded bits boundary, the wireless device 505 may perform rate matching (e.g., LDPC rate matching or BCC rate matching) on the one or more codewords. In some examples, factor a=4 may be used in BCC rate matching so that there is no post-FEC padding.

At 540, the wireless device 505-a may map the one or more codewords to at least one symbol fraction of the symbol of the one or more symbols based on the adjusted physical layer coded bits boundary.

At 545, the wireless device 505-a may transmit the packet to the wireless device 505-b according to the adjusted physical layer coded bits boundary. The packet may include at least the one or more codewords and the set of pre-FEC padding bits. Additionally, or alternatively, the packet may include a packet extension that spans a fixed duration (e.g., 0 microseconds, 4 microseconds, 8 microseconds, 12 microseconds, or 16 microseconds). Additionally, or alternatively, the packet or other signaling may include an indication of the second boundary (e.g., a_init), a parameter associated with the second boundary (e.g., a), or the at least one symbol segment of the last symbol, or an indication of the fixed duration of the packet extension. In some examples, the signaling including the indication of the second boundary may be included in the user field of each user because the boundary may be user dependent. Additional examples of the techniques described herein are provided in the attached appendix.

The following illustrates potential algorithms and equations that may be implemented for each of the options or schemes 0, 1, 2.0, and 2.1:

A two-step padding process may be applied to an extremely high throughput (EHT) physical layer protocol data unit (PPDU). A pre-FEC padding process including both pre-FEC MAC and pre-FEC PHY padding may be applied before conducting FEC coding, and a post-FEC PHY padding process may be applied on the FEC encoded bits.

Four pre-FEC padding boundaries may partition the last OFDM symbol of an EHT PPDU into four symbol segments. The pre-FEC padding may pad toward one of the four possible boundaries. The four pre-FEC padding boundaries may be represented by a common pre-FEC padding factor parameter a for all users.

The encoding process described in this subclause may apply to both an EHT single user (SU) transmission and a transmission of an EHT multiple user (MU) PPDU to multiple users.

### Step 1: Determine LDPC Pre-FEC Padding Boundary

In an EHT MU PPDU transmission, the transmitter may first compute the number of data bits left in the last OFDM symbol for user u as in the following equation.

$${N}_{Excess , u} = ( 8 \cdot {APEP}_{L E N G T {H}_{u}} + {N}_{tail , u} + {N}_{service} ) mod {N}_{DBPS , u}$$

APEP_LENGTHᵤ may be the TXVECTOR parameter APEP_LENGTH for the u-th user; N_{tail,u} may be the number of tail bits per encoder for user u, and N_{tail,u}=6 for BCC and N_{tail,u}=0 for LDPC; N_{service}=16 may be the number of bits in the SERVICE field; N_{DBPS,u}=floor(N_{BPSCS,u}·Rᵤ) may be the number of data bits per OFDM symbol for the u-th user, where Rᵤ may be the nominal coding rate for the u-th user; N_{CBPS,u}=N_{SD,u}·N_{ss,u}·N_{BPSCS,u} may be the number of coded bits per OFDM symbol for user u, in which N_{SD,u} may be the N_{SD} (effective number of data tones carrying unique data in one OFDM symbol) value corresponding to the occupied RU or MRU size of the u-th user, N_{ss,u} may be the number of spatial streams for the u-th user, and N_{BPSCS,u} may be the number of coded bits per OFDM symbol per spatial stream for user u. Based on N_{Excess,u}, the transmitter may then compute the initial number of symbol segments in the initial last OFDM symbol, i.e., initial pre-FEC padding factor value a_{init,u} and the initial number of OFDM symbols, N_{SYM,init,u}, for user u using the following equations.

$${a}_{init , u} = \{ \begin{matrix}4 , & if {N}_{Excess , u} = 0 \\ min ( ⌈ \frac{{N}_{Excess , u}}{{N}_{DBPS , short , u}} ⌉ , 4 ) , & otherwise\end{matrix}$$

$${N}_{S Y M , init , u} = ⌈ \frac{8 \cdot {APEP}_{L E N G T {H}_{u}} + {N}_{tail , u} + {N}_{s e r v i c e}}{{N}_{D B PS , u}} ⌉$$

N_{DBPS,short,u}=N_{CBPS,short,u}·Rᵤ, in which Rᵤ N_{CBPS,short,u}=N_{SD,short,u}·N_{ss,u}·N_{BPSCS,u}, and in which N_{SD,short,u} may be the N_{SD,short} (effective number of data tones carrying unique data in each symbol segment of the first three symbol segments) value corresponding to the occupied RU or MRU size of the u-th user.

Among all the users, the set of the user indices S may be derived, with the longest encoded packet duration as in the following equation, and one value may be selected from the set as uₘₐₓ.

$$S = arg {max}_{0 \leq u \leq {N}_{user , total - 1}} ( {N}_{SYM , init , u} - 1 + \frac{{a}_{init , u}}{4} )$$

$$arg max f ( x ) := \{ x ∈ [ 0 , {N}_{user , total} - 1 ] : f ( y ) \leq f ( x ) for all y ∈ [ 0 , {N}_{user , total} - 1 ] \}$$

Then the common aᵢₙᵢₜ and N_{SYM,init} values among all the users may be derived using the following equation

$${N}_{SYM , init} = {N}_{SYM , init , {u}_{max}}$$

$${a}_{init} = {a}_{init , {u}_{max}}$$

Next calculate each user's initial number of data bits N_{DBPS,last,init,u} and initial number of coded bits N_{CBPS,last,init,u} in its last OFDM symbol as shown in the following equations, respectively.

$${N}_{DBPS , last , init , u} = \{ \begin{matrix}{a}_{init} \cdot {N}_{DBPS , short , u} & if {a}_{init} < 4 \\ {N}_{DBPS , u} & if {a}_{init} = 4\end{matrix}$$

$${N}_{CBPS , last , init , u} = \{ \begin{matrix}{a}_{init} \cdot {N}_{CBPS , short , u} & if {a}_{init} < 4 \\ {N}_{CBPS , u} & if {a}_{init} = 4\end{matrix}$$

For each user with LDPC encoding, the parameters N_{pld,u} and N_{avbits,u} may be computed using the following equations, respectively.

N_{pld,u} is the PHY payload size, i.e., number of data bits including pre-FEC padding bits, that fits in the PHY payload boundary (or called pre-FEC padding boundary) which is the end of the symbol segment aᵢₙᵢₜ in the OFDM symbol N_{SYM,init}.

N_{avbits,u} may be the number of PHY coded bits that fits in the current PHY coded bits boundary which is the end of the symbol segment aᵢₙᵢₜ in the OFDM symbol N_{SYM,init}.

The effective code rate based on these two values may be

$${eCR}_{u} = \frac{{N}_{pld , u}}{{N}_{avbits , u}} = \frac{( {N}_{SYM , init} - 1 ) {N}_{DBPS , u} + {N}_{DBPS , last , init , u}}{( {N}_{SYM , init} - 1 ) {N}_{CBPS , u} + {N}_{CBPS , last , init , u}} = {R}_{u} ,$$

the nominal code rate Rᵤ of user u. If adjust the PHY coded bits boundary by adding one or more OFDM symbols and/or fraction of symbol (e.g., one or more symbol segments) to accommodate more PHY coded bits, we may lower the effective code rate and reduce puncturing ratio.

### Step 2: Determine LDPC Codeword Size and Number of Codewords

Compute the integer number of LDPC codewords to be transmitted for user u, N_{CW,u}, and the length of the codewords to be used for user u, L_{LDPC,u}, based on Table 2 (PPDU encoding parameters).

TABLE 2

| | Number of | LDPC codeword |
|---|---|---|
| Ranges of | LDPC | length |
| N_{avbits} (bits) | codewords (N_{CW}) | L_{LDPC} (bits) |
| N_{avbits} ≤ 648 | 1 | 1296, if N_{avbits} ≥ N_{pld} + 912 × |
| | | (1 − R) 648, otherwise |
| 648 < N_{avbits} ≤ 1296 | 1 | 1944, if N_{avbits} ≥ N_{pld} + 1464 × |
| | | (1 − R) 1296, otherwise |
| 1296 < N_{avbits} ≤ 1944 | 1 | 1944 |
| 1944 < N_{avbits} ≤ 2592 | 2 | 1944, if N_{avbits} ≥ N_{pld} + 2916 × |
| | | (1 − R )1296, otherwise |
| 2592 < N_{avbits} | $⌈ \frac{{N}_{p l d}}{1944 \cdot R} ⌉$ | 1944 |

### Step 3: Shortening

Compute the number of shortening bits for user u, N_{shrt,u}, to be padded to the N_{pld,u} data bits before encoding, as shown in the following equation.

$${N}_{shrt , u} = max ( 0 , {N}_{CW , u} \cdot {L}_{LDPC , u} \cdot {R}_{u} - {N}_{p l d , u} )$$

When N_{shrt,u}=0, shortening may not be performed. When N_{shrt,u}>0, shortening bits shall be equally distributed over all N_{CW,u} codewords with the first rem(N_{shrt,u}, N_{CW,u}) codewords being shortened one bit more than the remaining codewords. Shortening bits may be appended after data bits. The shortening bits may be discarded after encoding.

### Step 4: Puncturing/Repetition

Compute the number of bits to be punctured for user u, N_{punc,u}, from the codewords after encoding, as follows.

$${N}_{p u n c , u} = max ( 0 , {N}_{CW , u} \cdot {L}_{LDPC , u} - {N}_{avbits , u} - {N}_{shrt , u} )$$

When N_{punc,u}=0, puncturing is not performed. When N_{punc,u}>0, puncturing bits may be equally distributed over all N_{CW,u} codewords with the first rem(N_{punc,u}, N_{CW,u}) codewords being punctured one bit more than the remaining codewords. Only parity bits may be punctured.

If there is at least one user with LDPC encoding for which the following condition in LDPC encoding process is met:

$$( {N}_{punc , u} > 0.1 \cdot {N}_{CW , u} \cdot {L}_{LDPC , u} \cdot ( 1 - {R}_{u} ) ) AND ( {N}_{shrt} < 1.2 \cdot {N}_{punc , u} \cdot {R}_{u} / ( 1 - {R}_{u} )$$

is true OR if

$${N}_{punc , u} > 0.3 \cdot {N}_{CW , u} \cdot {L}_{LDPC , u} \cdot ( 1 - {R}_{u} )$$

is true, for any user u, all users with LDPC encoding shall increment N_{avbits,u} by an extra symbol segment and recompute N_{punc,u} based on the new N_{avbits,u} value.

$${N}_{avbits , u} = \{ \begin{matrix}{N}_{avbits , u} + {N}_{CBPS , u} - 3 {N}_{CBPS , short , u} , & if {a}_{init} = 3 \\ {N}_{avbits , u} + {N}_{CBPS , short , u} , & otherwise\end{matrix}$$

Then update the common pre-FEC padding factor a and N_{SYM} values for all users using the following

$$\{ \begin{matrix}{N}_{S Y M} = {N}_{S Y M , init} + 1 and a = 1 , & if {a}_{init} = 4 \\ {N}_{S Y M} = {N}_{SYM , init} and a = {a}_{init} + 1 & otherwise\end{matrix}$$

Note that the last OFDM symbol may be the next OFDM symbol of the initial last OFDM symbol in this case, if aᵢₙᵢₜ=4. Since N_{avbits,u} may be updated with a larger value, more PHY coded bits fit in the adjusted PHY coded bits boundary which is the end of the symbol segment a in the OFDM symbol N_{SYM}.

On the other hand, if the above condition in LDPC encoding process is not met by any of the users with LDPC encoding, or if all the users scheduled in the EHT MU PPDU are BCC encoded, no extra symbol segment may be added. Then update the common pre-FEC padding factor a and N_{SYM} values for all users using the following
N_{SYM}=N_{SYM,init} and a=aᵢₙᵢₜ

Compute the number of coded bits to be repeated for user u, N_{rep,u}, as follows.

$${N}_{rep , u} = max ( 0 , {N}_{a vbits , u} - {N}_{CW , u} \cdot {L}_{LDPC , u} \cdot ( 1 - {R}_{u} ) - {N}_{p l d , u} )$$

When N_{rep,u}=0, repetition is not performed. When N_{rep,u}>0, the number of coded bits to be repeated may be equally distributed over all N_{CW,u} codewords with one more bit repeated for the first rem(N_{rep,u}, N_{CW,u}) codewords than the remaining codewords. The coded bits to be repeated for any codeword may be copied only from that codeword itself, starting from the beginning of that LDPC codeword (beginning of data bits).

When puncturing occurs, the coded bits may not be repeated, and vice versa.

### Step 5: Finalize the LDPC/BCC Pre-FEC Padding and Post-FEC Padding

For the users with LDPC encoding, update N_{DBPS} of the last OFDM symbol as
N_{DBPS,last,u}=N_{DBPS,last,init,u}

For the users with BCC encoding, update N_{DBPS} of the last OFDM symbol as

$${N}_{DBPS , last , u} = \{ \begin{matrix}a \cdot {N}_{DBPS , short , u} & if a < 4 \\ {N}_{DBP , u} & if a = 4\end{matrix}$$

For each user with either LDPC or BCC encoding, update N_{CBPS} of the last OFDM symbol as

$${N}_{CBPS , last , u} = \{ \begin{matrix}a \cdot {N}_{C BPS , short , u} , & if a < 4 \\ {N}_{C B P S , u} , & if a = 4\end{matrix}$$

For each user with LDPC encoding, the number of pre-FEC padding bits for the u-th user may be computed as in the following equation.

$${N}_{PAD , Pre - F EC , u} = ( {N}_{S YM , init} - 1 ) {N}_{D B PS , u} + {N}_{D B PS , last , init , u} - 8 \cdot APE {P}_{L E N G T {H}_{u}} - {N}_{s e r v i c e}$$

The PHY payload boundary (or called pre-FEC padding boundary) for users using LDPC encoding may be the end of the symbol segment aᵢₙᵢₜ in the OFDM symbol N_{SYM,init}, only determined by N_{SYM,init} and aᵢₙᵢₜ.

For the users with BCC encoding, the number of pre-FEC padding bits for the u-th user may be shown in the following equation.

$${N}_{PAD , Pre - FEC , u} = ( {N}_{S Y M} - 1 ) {N}_{DBPS , u} + {N}_{DBPS , last , u} - 8 \cdot {APEP}_{L E N G T {H}_{u}} - {N}_{tail , u} - {N}_{s e r v i c e}$$

For users using BCC encoding, both the PHY payload boundary (or called pre-FEC padding boundary) and the PHY coded bits boundary may be the same as the end of the symbol segment a in the OFDM symbol N_{SYM}, determined by N_{SYM} and a.

For each user with either LDPC or BCC encoding, the number of post-FEC padding bits in the last symbol may be computed as in the following equation.

$${N}_{PAD , Post - FEC , u} = {N}_{C B P S , u} - {N}_{CBPS , last , u}$$

The post-FEC padding fill the data tones not occupied by PHY coded bits in the last OFDM symbol, i.e., the remaining symbol segments in the last OFDM symbol.

Among the pre-FEC padding bits, the MAC may deliver a PSDU that fills the available octets in the Data field of the EHT PPDU, toward the desired initial pre-FEC padding boundary represented by aᵢₙᵢₜ for users encoded by LDPC, and toward the desired pre-FEC padding boundary represented by a for users encoded by BCC, in the last OFDM symbol. The PHY may then determine the number of padding bits to add and may append them to the PSDU. The number of pre-FEC padding bits added by PHY may be 0 to 7.

### Option/Scheme 1

In Scheme 1, keep the pre-FEC padding as in 11be, but no puncturing or repetition step. All data bits (after discarding shortening bits) and parity bits may be transmitted. Steps 1-3 may be the same as in 11be. The number of PHY coded bits for user u may be modified as

$${N}_{a vbits , u} = {N}_{p l d , u} + {N}_{CW , u} \cdot {L}_{LDPC , u} \cdot ( 1 - {R}_{u} )$$

The final number of OFDM symbols may be calculated as

$${N}_{SYM , u} = ⌈ \frac{{N}_{avbits , u}}{{N}_{C B PS , u}} ⌉$$

The number of PHY coded bits left in the last OFDM symbol for user u may be calculated as

N_{CBPS,last,u}=N_{avbits,u} mod N_{CBPS,u}

Note that this number may not align with an OFDM symbol segment boundary. The number of post-FEC padding bits in the last OFDM symbol for user u which is partially occupied by PHY coded bits may be calculated as

$${N}_{PAD , Post - FEC , u} = {N}_{C B P S , u} - {N}_{CBPS , last , u}$$

If there are more than one user (N_{user,total}>1), the last OFDM symbol in Data field N_{SYM} may be determined based on the largest N_{SYM,u} among all users. Some users may have post-FEC padding OFDM symbols to match N_{SYM} if N_{SYM}>N_{SYM,u}.

Note that in 802.11ax/11be, the common pre-FEC padding factor a (instead of a_init) is signaled in the common info field in PHY preamble. But in scheme 1, we change the signaling as following. In the common info field in PHY preamble, need to signal the pre-FEC padding factor aᵢₙᵢₜ for LDPC (instead of a as in 802.11ax/11be) and the initial number of OFDM symbol N_{SYM,init} to determine the pre-FEC padding boundary at receiver. Alternatively, we can signal the pre-FEC padding factor aᵢₙᵢₜ for LDPC (instead of a as in 802.11ax/11be) and the additional number of OFDM symbols (N_{SYM}−N_{SYM,init}).

### Option/Scheme 2.0

In Scheme 2.0, the pre-FEC padding may be the same as in 11be. To adjust the PHY coded bits boundary, firstly conditionally add one extra symbol segment based on checking the condition in Step 4 (Puncturing/Repetition) and then further force the PHY coded bits boundary to the end of the last OFDM symbol (i.e., a=4).

When aᵢₙᵢₜ<4, no matter whether the condition is met and an extra symbol segment would be firstly added or not, the last OFDM symbol doesn't change, i.e., N_{SYM}=N_{SYM,init}. When aᵢₙᵢₜ=4, if the condition is not met, the last OFDM symbol may not change, i.e., N_{SYM}=N_{SYM,init}; otherwise, if the condition is met, the last OFDM symbol may be the next OFDM symbol after the initial last OFDM symbol, i.e., N_{SYM}=N_{SYM,init}+1.

In PHY preamble, the pre-FEC padding factor aᵢₙᵢₜ (instead of a as in 802.11ax/11be) may be signaled and if the condition is met or not (by reusing the LDPC Extra Symbol Segment bit in 802.11ax/11be).

### Option/Scheme 2.1

In Scheme 2.1, keep the pre-FEC padding as in 11be. To adjust the PHY coded bits boundary, firstly always add one extra symbol segment and then further force the PHY coded bits boundary to the end of the last OFDM symbol (i.e., a=4). It is not based on the condition.

When aᵢₙᵢₜ<4, the last OFDM symbol doesn't change, i.e., N_{SYM}=N_{SYM,init}. When aᵢₙᵢₜ=4, the last OFDM symbol is the next OFDM symbol after the initial last OFDM symbol, i.e., N_{SYM}=N_{SYM,init}+1.

In PHY preamble, the pre-FEC padding factor aᵢₙᵢₜ (instead of a as in 802.11ax/11be) may be signaled. In some examples, the LDPC Extra Symbol Segment bit defined in 802.11ax/11be may be removed.

### Option/Scheme 0

Similar to the BCC rate matching, the pre-FEC padding boundary and PHY coded bits boundary may be the same. No shortening, puncturing/repetition steps. The LDPC codeword size may equal the nominal size within the set of {648, 1296, 1944} (may also include 1944×2). The number of PHY coded bits may equal to an integer number of LDPC codewords multiplied by the codeword size.

Use N_{SYM} and the symbol segment factor a in the last OFDM symbol to determine the boundaries. The pre-FEC padding boundary and PHY coded bits boundary may be within the boundary determined by N_{SYM} and the symbol segment factor a and uniquely determined based on these two values. Let the number of LDPC codewords be the maximum number of LDPC codewords that fit up to the symbol segment factor a in the last OFDM symbol. Do pre-FEC padding to fit to this number of LDPC codewords. Do post-FEC padding after the end of PHY coded bits boundary till the end of the last OFDM symbol.

In PHY preamble, only need to signal the symbol segment factor a value.

To uniquely determine the LDPC codeword size, may need to modify the rules (table) into an algorithm to determine the LDPC codeword size to avoid ambiguity between transmitter and receiver. For simplicity, if the largest codeword size is 1944, may assume up to 1 LDPC codeword if size 648 or 1296 is used. If the largest codeword size is 3888, may assume up to 1 LDPC codeword if size 648, 1296 or 1944 is used. In the algorithm description, we may assume only using LDPC codeword sizes 648, 1296 and 1944 for simplicity. The algorithm may be extended to using LDPC codeword sizes 648, 1296, 1944 and 3888.

Scheme 0 may have a different algorithm to determine the LDPC codeword size, number of LDPC codewords and number of pre-FEC padding bits, compared to 11be. The algorithm at transmitter and that at receiver may be different.

First, define the PHY payload size before adding pre-FEC padding for user u as the same as in 802.11n.

$${N}_{pld 11 n , u} = 8 \cdot {APEP}_{L E N G T {H}_{u}} + {N}_{s e r v i c e}$$

### Algorithm at Transmitter

The candidate set of LDPC codeword size may be L_{LDPC,candidate}={648, 1296, 1944}. The maximum number of codewords for each of the candidates are N_{CW,candiate,max}={1, 1, Inf}.

For each candidate, assume the i-th candidate L_{LDPC,i}∈L_{LDPC,candidate}, i=1, 2, 3, calculate the minimum number of LDPC codewords for user u to fit in all N_{pld11n,u} information bits as follows.

$${N}_{C W , u , i , min} = ⌈ \frac{{N}_{pld 11 n , u}}{{L}_{L D PC , i} \cdot {R}_{u}} ⌉$$

Then, calculate the minimum number of PHY coded bits for the i-th candidate L_{LDPC,i} for user u as follows.

$${N}_{a vbits , u , i , min} = {N}_{C W , u , i , min} \cdot {L}_{LDPC , i}$$

Determine the number of OFDM symbols for the i-th candidate L_{LDPC,i} for user u to transmit N_{avbits,u,i,min} PHY coded bits as follows.

$${N}_{SYM , u , i} = ⌈ \frac{{N}_{avbits , u , i , min}}{{N}_{C B PS , u}} ⌉$$

And the minimum number of PHY coded bits left in the last OFDM symbol for user u for the i-th candidate L_{LDPC,i} is calculated as

N_{CBPS,last,u,i,min}=N_{avbits,u,i,min} mod N_{CBPS,u}

Determine the number of symbol segment for the i-th candidate L_{LDPC,i} for user u as follows.

$${a}_{u , i} = \{ \begin{matrix}4 , & if {N}_{CBPS , last , u , i , min} = 0 \\ min ( ⌈ \frac{{N}_{CBPS , last , u , i , min}}{{N}_{CBPS , short , u}} ⌉ , 4 ) , & otherwise\end{matrix}$$

Calculate the maximum number of PHY coded bits left in the last OFDM symbol for user u for the i-th candidate L_{LDPC,i} based on the symbol segment boundary as follows.

$${N}_{CBPS , last , u , i} = \{ \begin{matrix}{a}_{u , i} \cdot {N}_{CBPS , short , u} & if {a}_{u , i} < 4 \\ {N}_{CBPS , u} & if {a}_{u , i} = 4\end{matrix}$$

Calculate the maximum number of PHY coded bits for the i-th candidate L_{LDPC,i} for user u based on the symbol segment boundary as follows.

$${N}_{avbits , u , i , max} = ( {N}_{SYM , u , i} - 1 ) {N}_{CBPS , u} + {N}_{CBPS , last , u , i}$$

Calculate the final number of LDPC codewords for user u for the i-th candidate L_{LDPC,i} as follows. This may be the number of LDPC codewords used to transmit the given PHY payload if using the LDPC codeword size L_{LDPC,i}.

$${N}_{CW , u , i} = ⌊ \frac{{N}_{avbits , u , i , max}}{{L}_{LDPC , i}} ⌋$$

Calculate the final number of PHY coded bits for user u for the i-th candidate L_{LDPC,i} as follows.

$${N}_{avbits , u , i} = {N}_{CW , u , i} \cdot {L}_{LDPC , i}$$

To determine the LDPC codeword size, may use the following three criteria:

1) N_{CW,u,i} satisfies N_{CW,u,i}≤N_{CW,i,max} where N_{CW,i,max}∈N_{CW,candiate,max} may be the maximum number of LDPC codewords for the i-th candidate L_{LDPC,i}.

2) After 1), if there are more than one LDPC codeword size candidates, may choose the one(s) that has minimum number of PHY payload coded bits as follows.

$${S}_{u} = arg {min}_{i} ( {N}_{avbits , u , i} )$$

Or choose the one(s) that has minimum number of OFDM symbols and number of symbol segments as follows.

$${S}_{u} = arg {min}_{i} ( {N}_{SYM , u , i} - 1 + \frac{{a}_{u , i}}{4} )$$

After 2), if there are more than one LDPC codeword size candidates, may choose the one that has the largest LDPC codeword size as follows.

$${S}_{u , final} = arg {max}_{i ∈ {S}_{u}} ( {L}_{LDPC , i} )$$

The choice of LDPC codeword size is L_{LDPC,i}, i∈S_{u,final}. And the number of LDPC codewords may be N_{CW,u,i}, i∈S_{u,final}. The final number of OFDM symbols, number of symbol segments, and number of PHY coded bits in the last OFDM symbol of user u may be the following.

$${N}_{SYM , u} = {N}_{SYM , u , i} , {a}_{u} = {a}_{u , i} , {N}_{CBPS , last , u} = {N}_{avbits , u , i} mod {N}_{CBPS , u} , i ∈ {S}_{u , final}$$

Calculate the number of pre-FEC padding bits according to the LDPC codeword size and the number of codewords as follows.

$${N}_{PAD , Pre - FEC , u} = {N}_{CW , u , i} \cdot {L}_{LDPC , i} \cdot {R}_{u} - {N}_{pld 11 n , u} , i ∈ {S}_{u , final}$$

Calculate the number of post-FEC padding bits according to the unoccupied as follows.

$${N}_{PAD , Post - FEC , u} = {N}_{CBPS , u} - {N}_{CBPS , last , u}$$

If there are more than one user (N_{user,total}>1), the last OFDM symbol in Data field N_{SYM} is determined based on the largest N_{SYM,u} among all users. Some users may have post-FEC padding OFDM symbols to match N_{SYM} if N_{SYM}>N_{SYM,u}. The packet extension duration may be determined based on the largest

$$( {N}_{SYM , u} - 1 + \frac{{a}_{u}}{4} )$$

among all users.

In the user info field in PHY preamble, may also signal the number of OFDM symbols N_{SYM,u} and/or number of symbol segment aᵤ to determine the pre-FEC padding boundary and PHY coded bits boundary for user u.

### Algorithm at Receiver

Based on the signaling of the number of OFDM symbols N_{SYM,u} and/or number of symbol segment aᵤ, calculate the maximum number of PHY coded bits for the i-th candidate L_{LDPC,i} for user u based on the symbol segment boundary as follows.

$${N}_{avbits , u , max} = ( {N}_{SYM , u} - 1 ) {N}_{CBPS , u} + {N}_{CBPS {,}_{} last , u , max}$$

where the number of PHY coded bits left in the last OFDM symbol for user u is as follows

$${N}_{CBPS , last , u} = \{ \begin{matrix}{a}_{u} \cdot {N}_{CBPS , short , u} & if {a}_{u , i} < 4 \\ {N}_{CBPS , u} & if {a}_{u , i} = 4\end{matrix}$$

Calculate the number of LDPC codewords for user u for the i-th candidate L_{LDPC,i} as follows. This is the number of LDPC codewords used to transmit the given PHY payload if using the LDPC codeword size L_{LDPC,i}

$${N}_{CW , u , i} = ⌊ \frac{{N}_{avbits , u , max}}{{L}_{LDPC , i}} ⌋$$

To determine the LDPC codeword size, may use the following two criteria:

1) N_{CW,u,i} satisfies N_{CW,u,i}≤N_{CW,i,max} where N_{CW,i,max}∈N_{CW,candiate,max} may be the maximum number of LDPC codewords for the i-th candidate L_{LDPC,i}.

After 1), if there are more than one LDPC codeword size candidates, choose the one that has the largest LDPC codeword size as follows.

$${S}_{u , final} = arg {max}_{i ∈ {S}_{u}} ( {L}_{LDPC , i} )$$

The choice of LDPC codeword size is L_{LDPC,i}, i∈S_{u,final}. And the number of LDPC codewords is N_{CW,u,i}, i∈S_{u,final}

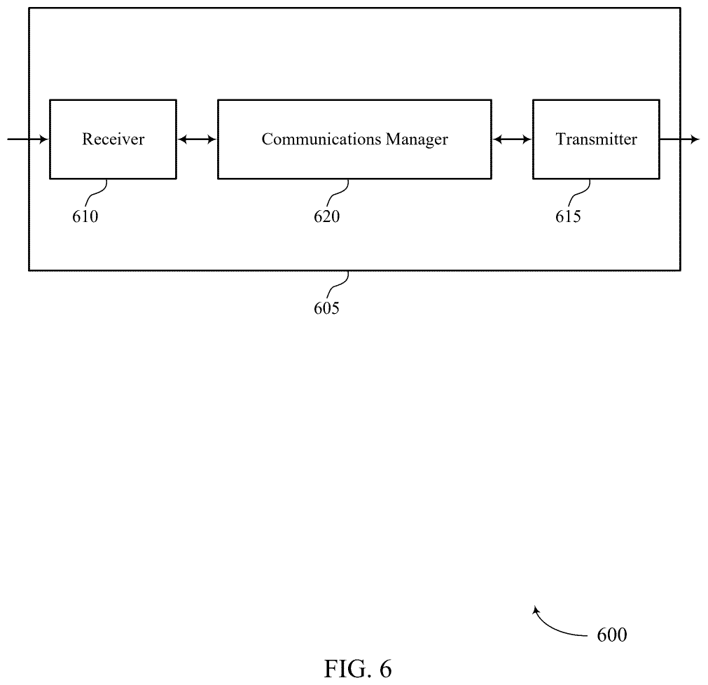

FIG. 6 shows a block diagram 600 of a device 605 that supports techniques for LDPC rate matching in accordance with one or more aspects of the present disclosure. The device 605 may be an example of aspects of an AP or a STA as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for LDPC rate matching). Information may be passed on to other components of the device 605. The receiver 610 may utilize a single antenna or a set of multiple antennas.

The transmitter 615 may provide a means for transmitting signals generated by other components of the device 605. The transmitter 615 may utilize a single antenna or a set of multiple antennas.

The communications manager 620, the receiver 610, the transmitter 615, or various combinations or components thereof may be examples of means for performing various aspects of techniques for LDPC rate matching as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. For example, the communications manager 620 is capable of, configured to, or operable to support a means for generating one or more LDPC codewords based on performing LDPC encoding on data, each codeword of the one or more LDPC codewords including a respective set of data bits and a respective set of parity bits. The communications manager 620 is capable of, configured to, or operable to support a means for adding one or more symbols or one or more symbol fractions to a first boundary of a packet to generate an adjusted first boundary, the first boundary specifying a first number of symbols of the packet allocated for the one or more LDPC codewords, where a puncturing ratio associated with the one or more LDPC codewords is reduced (e.g., from a first non-zero value to a second non-zero value) or set to zero. The communications manager 620 is capable of, configured to, or operable to support a means for transmitting, to a second wireless device, the packet including the one or more LDPC codewords that includes a set of pre-FEC padding bits based on the adjusted first boundary.

Additionally, or alternatively, the communications manager 620 may support wireless communication in accordance with examples as disclosed herein. For example, the communications manager 620 is capable of, configured to, or operable to support a means for generating one or more codewords based on performing LDPC encoding on data, each of the one or more codewords including at least a respective set of parity bits and a respective set of data bits. The communications manager 620 is capable of, configured to, or operable to support a means for adjusting a physical layer coded bits boundary associated with the one or more codewords to be a value that corresponds to a last symbol fraction of a last symbol of one or more symbols of a data field of a packet. The communications manager 620 is capable of, configured to, or operable to support a means for mapping the one or more codewords to at least one symbol fraction of the last symbol of the one or more symbols based on the adjusted physical layer coded bits boundary. The communications manager 620 is capable of, configured to, or operable to support a means for transmitting, to a second wireless device, the packet via the one or more symbols based on mapping the one or more codewords.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for increased receiver reliability.

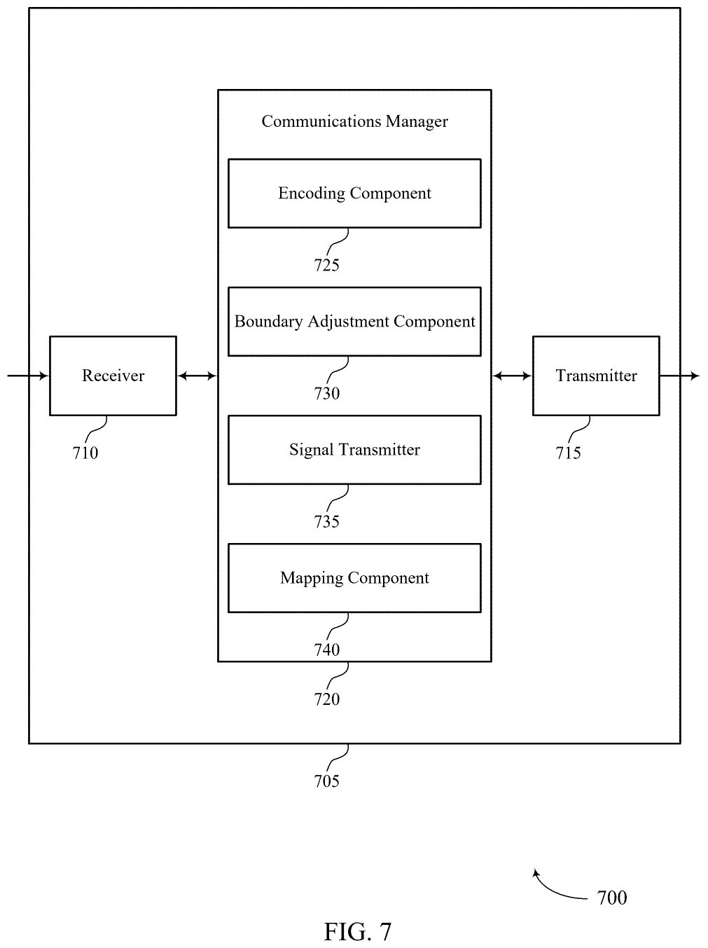

FIG. 7 shows a block diagram 700 of a device 705 that supports techniques for LDPC rate matching in accordance with one or more aspects of the present disclosure. The device 705 may be an example of aspects of a device 605, an AP 105, or a STA 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for LDPC rate matching). Information may be passed on to other components of the device 705. The receiver 710 may utilize a single antenna or a set of multiple antennas.

The transmitter 715 may provide a means for transmitting signals generated by other components of the device 705. The transmitter 715 may utilize a single antenna or a set of multiple antennas.

The device 705, or various components thereof, may be an example of means for performing various aspects of techniques for LDPC rate matching as described herein. For example, the communications manager 720 may include an encoding component 725, a boundary adjustment component 730, a signal transmitter 735, a mapping component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. The encoding component 725 is capable of, configured to, or operable to support a means for generating one or more LDPC codewords based on performing LDPC encoding on data, each codeword of the one or more LDPC codewords including a respective set of data bits and a respective set of parity bits. The boundary adjustment component 730 is capable of, configured to, or operable to support a means for adding one or more symbols or one or more symbol fractions to a first boundary of a packet to generate an adjusted first boundary, the first boundary specifying a first number of symbols of the packet allocated for the one or more LDPC codewords, where a puncturing ratio associated with the one or more LDPC codewords is reduced (e.g., from a first non-zero value to a second non-zero value) or set to zero. The signal transmitter 735 is capable of, configured to, or operable to support a means for transmitting, to a second wireless device, the packet including the one or more LDPC codewords that include a set of pre-FEC padding bits based on the adjusted first boundary.

Additionally, or alternatively, the communications manager 720 may support wireless communication in accordance with examples as disclosed herein. The encoding component 725 is capable of, configured to, or operable to support a means for generating one or more codewords based on performing LDPC encoding on data, each of the one or more codewords including at least a respective set of parity bits and a respective set of data bits. The boundary adjustment component 730 is capable of, configured to, or operable to support a means for adjusting a physical layer coded bits boundary associated with the one or more codewords to be a value that corresponds to a last symbol fraction of a last symbol of one or more symbols of a data field of a packet. The mapping component 740 is capable of, configured to, or operable to support a means for mapping the one or more codewords to at least one symbol fraction of the last symbol of the one or more symbols based on the adjusted physical layer coded bits boundary. The signal transmitter 735 is capable of, configured to, or operable to support a means for transmitting, to a second wireless device, the packet via the one or more symbols based on mapping the one or more codewords.

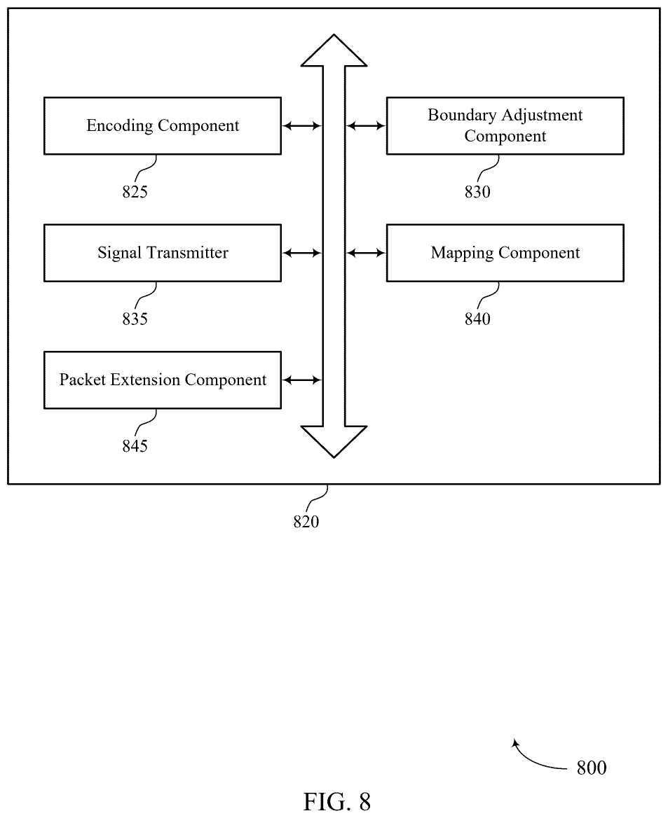

FIG. 8 shows a block diagram 800 of a communications manager 820 that supports techniques for LDPC rate matching in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for LDPC rate matching as described herein. For example, the communications manager 820 may include an encoding component 825, a boundary adjustment component 830, a signal transmitter 835, a mapping component 840, a packet extension component 845, or any combination thereof. Each of these components, or components or subcomponents thereof (e.g., one or more processors, one or more memories), may communicate, directly or indirectly, with one another (e.g., via one or more buses).

The communications manager 820 may support wireless communication in accordance with examples as disclosed herein. The encoding component 825 is capable of, configured to, or operable to support a means for generating one or more LDPC codewords based on performing LDPC encoding on data, each codeword of the one or more LDPC codewords including a respective set of data bits and a respective set of parity bits. The boundary adjustment component 830 is capable of, configured to, or operable to support a means for adding one or more symbols or one or more symbol fractions to a first boundary of a packet to generate an adjusted first boundary, the first boundary specifying a first number of symbols of the packet allocated for the one or more LDPC codewords, where a puncturing ratio associated with the one or more LDPC codewords is reduced (e.g., from a first non-zero value to a second non-zero value) or set to zero. The signal transmitter 835 is capable of, configured to, or operable to support a means for transmitting, to a second wireless device, the packet including the one or more LDPC codewords that includes a set of pre-FEC padding bits based on the adjusted first boundary.

In some examples, the boundary adjustment component 830 is capable of, configured to, or operable to support a means for identifying a physical layer coded bits boundary that specifies a second number of symbols of the packet allocated for the one or more LDPC codewords, where the first boundary includes a physical layer payload boundary, and where the physical layer coded bit boundary is based at least in part on the adjusted first boundary.

In some examples, the mapping component 840 is capable of, configured to, or operable to support a means for mapping the one or more LDPC codewords to the second number of symbols of the packet and up to the physical layer coded bits boundary of the packet.

In some examples, the boundary adjustment component 830 is capable of, configured to, or operable to support a means for transmitting, to the second wireless device, signaling indicating the physical layer coded bits boundary or a parameter associated with the physical layer coded bits boundary.

In some examples, the one or more LDPC codewords transmitted to the second wireless device include a nominal size of 648 bytes, 1296 bytes, 1944 bytes, or 3888 bytes that is based on the physical layer coded bits boundary. In some examples, the one or more LDPC codewords transmitted to the second wireless device include the nominal size without shortening, puncturing, or repeating bits

In some examples, the boundary adjustment component 830 is capable of, configured to, or operable to support a means for transmitting, to the second wireless device, signaling indicating one or both of the one or more symbols or the one or more symbol fractions added to the first boundary.

In some examples, the encoding component 825 is capable of, configured to, or operable to support a means for generating one or more second LDPC codewords based on performing the LDPC encoding on the data, each of the one or more second LDPC codewords including the respective set of data bits, a respective set of shortening bits, and the respective set of parity bits. In some examples, the encoding component 825 is capable of, configured to, or operable to support a means for discarding the respective sets of shortening bits, where generating the one or more LDPC codewords is based on the one or more second LDPC codewords and on discarding the respective sets of shortening bits.

In some examples, the mapping component 840 is capable of, configured to, or operable to support a means for mapping the one or more LDPC codewords and the set of pre-FEC padding bits to the first number of symbols of the packet and up to the adjusted first boundary of the packet.

In some examples, the packet further includes a packet extension that spans a fixed duration of 0 microseconds, 4 microseconds, 8 microseconds, 12 microseconds, or 16 microseconds, and the packet extension component 845 is capable of, configured to, or operable to support a means for transmitting, to the second wireless device, signaling including an indication of the fixed duration of the packet extension. In some examples, the packet further includes a packet extension that spans a fixed duration.

In some examples, a symbol fraction includes one or more symbol segments, each symbol segment spanning a fraction of a symbol, the fraction including ¼ of a symbol or ⅛ of a symbol.

Additionally, or alternatively, the communications manager 820 may support wireless communication in accordance with examples as disclosed herein. In some examples, the encoding component 825 is capable of, configured to, or operable to support a means for generating one or more codewords based on performing LDPC encoding on data, each of the one or more codewords including at least a respective set of parity bits and a respective set of data bits. In some examples, the boundary adjustment component 830 is capable of, configured to, or operable to support a means for adjusting a physical layer coded bits boundary associated with the one or more codewords to be a value that corresponds to a last symbol fraction of a last symbol of one or more symbols of a data field of a packet. The mapping component 840 is capable of, configured to, or operable to support a means for mapping the one or more codewords to at least one symbol fraction of the last symbol of the one or more symbols based on the adjusted physical layer coded bits boundary. In some examples, the signal transmitter 835 is capable of, configured to, or operable to support a means for transmitting, to a second wireless device, the packet via the one or more symbols based on mapping the one or more codewords.

In some examples, the boundary adjustment component 830 is capable of, configured to, or operable to support a means for identifying a pre-FEC padding bit boundary associated with the set of pre-FEC padding bits, where generating the one or more codewords is based on identifying a pre-FEC padding bit boundary, the one or more codewords including the set of pre-FEC padding bits

In some examples, the boundary adjustment component 830 is capable of, configured to, or operable to support a means for transmitting, to the second wireless device, signaling including one or more of an indication of the pre-FEC padding bit boundary an indication of a parameter associated with the pre-FEC padding bit boundary, or an indication that a condition has been satisfied.

In some examples, the boundary adjustment component 830 is capable of, configured to, or operable to support a means for performing rate matching on the one or more codewords, where the rate matching includes LDPC rate matching.

In some examples, the packet includes a packet extension that spans a fixed duration of 0 microseconds, 4 microseconds, 8 microseconds, or 16 microseconds, and the packet extension component 845 is capable of, configured to, or operable to support a means for transmitting, to the second wireless device, signaling including an indication of the fixed duration of the packet extension.

In some examples, the packet further includes a packet extension that spans a fixed duration.

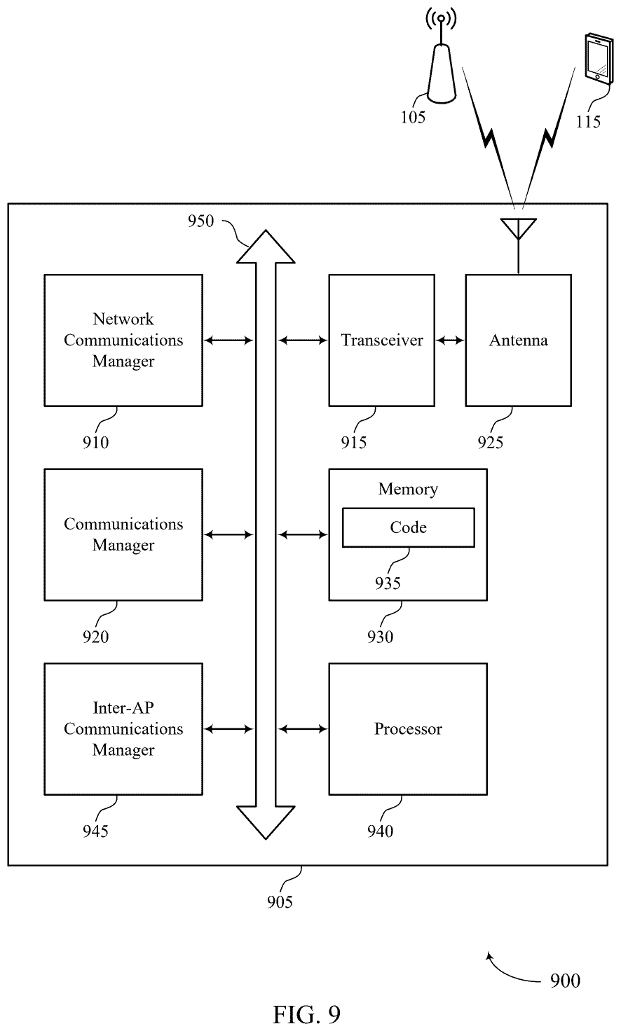

FIG. 9 shows a diagram of a system 900 including a device 905 that supports techniques for LDPC rate matching in accordance with one or more aspects of the present disclosure. The device 905 may be an example of or include components of a device 605, a device 705, or an AP as described herein. The device 905 may include components for bi-directional voice and data communications including components for transmitting and receiving communications, such as a communications manager 920, a network communications manager 910, a transceiver 915, one or more antennas 925, at least one memory 930, code 935, at least one processor 940, and an inter-AP communications manager 945. These components may be in electronic communication or otherwise coupled (e.g., operatively, communicatively, functionally, electronically, electrically) via one or more buses (e.g., a bus 950).

The network communications manager 910 may manage communications with a core network (e.g., via one or more wired backhaul links). For example, the network communications manager 910 may manage the transfer of data communications for client devices, such as one or more STAs 115.

In some cases, the device 905 may include a single antenna. However, in some other cases the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets and provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include RAM and ROM. The at least one memory 930 may store computer-readable, computer-executable, or processor-executable code, such as the code 935. The code 935 may include instructions that, when executed by the at least one processor 940, cause the device 905 to perform various functions described herein. In some cases, the at least one memory 930 may include, among other things, a BIOS which may control basic hardware or software operation such as the interaction with peripheral components or devices.

The at least one processor 940 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting techniques for LDPC rate matching). For example, the device 905 or a component of the device 905 may include at least one processor 940 and at least one memory 930 coupled with or to the processor 940, the at least one processor 940 and at least one memory 930 configured to perform various functions described herein.

An inter-station communications manager may manage communications with other APs 105, and may include a controller or scheduler for controlling communications with STAs 115 in cooperation with other APs 105. For example, the inter-station communications manager may coordinate scheduling for transmissions to APs 105 for various interference mitigation techniques such as beamforming or joint transmission. In some examples, the inter-station communications manager may provide an X2 interface within an LTE/LTE-A wireless communication network technology to provide communication between APs 105.

The communications manager 920 may support wireless communication in accordance with examples as disclosed herein. For example, the communications manager 920 is capable of, configured to, or operable to support a means for generating one or more LDPC codewords based on performing LDPC encoding on data, each codeword of the one or more LDPC codewords including a respective set of data bits and a respective set of parity bits. The communications manager 920 is capable of, configured to, or operable to support a means for adding one or more symbols or one or more symbol fractions to a first boundary of a packet to generate an adjusted first boundary, the first boundary specifying a first number of symbols of the packet allocated for the one or more LDPC codewords, where a puncturing ratio associated with the one or more LDPC codewords is reduced (e.g., from a first non-zero value to a second non-zero value) or set to zero. The communications manager 920 is capable of, configured to, or operable to support a means for transmitting, to a second wireless device, the packet including the one or more LDPC codewords that includes a set of pre-FEC padding bits based on the adjusted first boundary.

Additionally, or alternatively, the communications manager 920 may support wireless communication in accordance with examples as disclosed herein. For example, the communications manager 920 is capable of, configured to, or operable to support a means for generating one or more codewords based on performing LDPC encoding on data, each of the one or more codewords including at least a respective set of parity bits and a respective set of data bits. The communications manager 920 is capable of, configured to, or operable to support a means for adjusting a physical layer coded bits boundary associated with the one or more codewords to be a value that corresponds to a last symbol fraction of a last symbol of one or more symbols of a data field of a packet. The communications manager 920 is capable of, configured to, or operable to support a means for mapping the one or more codewords to at least one symbol fraction of the last symbol of the one or more symbols based on the adjusted physical layer coded bits boundary. The communications manager 920 is capable of, configured to, or operable to support a means for transmitting, to a second wireless device, the packet via the one or more symbols based on mapping the one or more codewords.

By including or configuring the communications manager 920 in accordance with examples as described herein, the device 905 may support techniques for improved communication reliability.

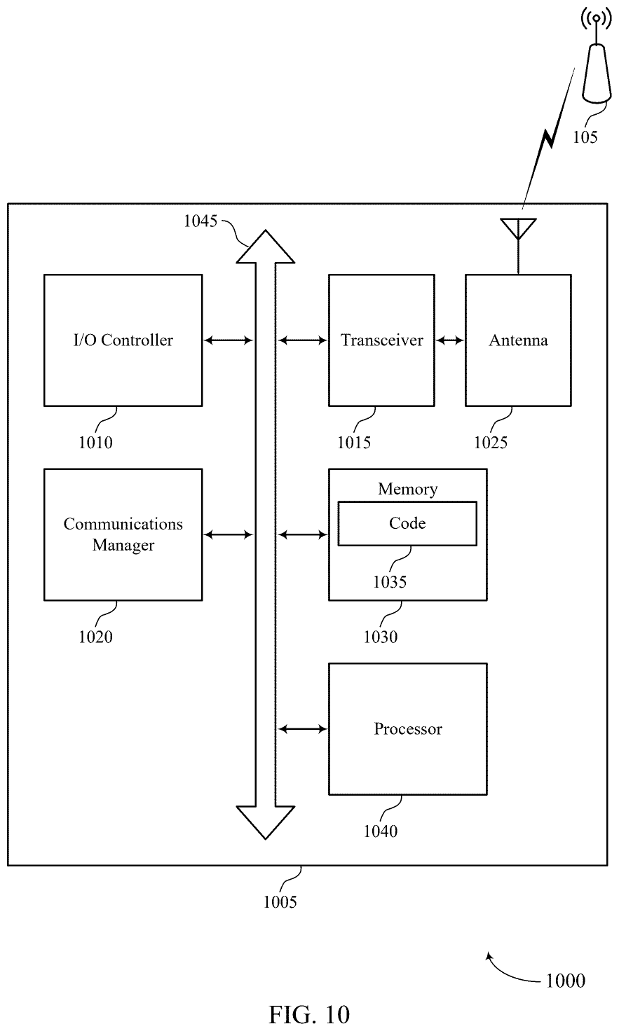

FIG. 10 shows a diagram of a system 1000 including a device 1005 that supports techniques for LDPC rate matching in accordance with one or more aspects of the present disclosure. The device 1005 may be an example of or include components of a device 605, a device 705, or a STA as described herein. The device 1005 may include components for bi-directional voice and data communications including components for transmitting and receiving communications, such as a communications manager 1020, an I/O controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. In some other cases, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna. However, in some other cases the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets and provide the modulated packets to one or more antennas 1025 for transmission, and to demodulate packets received from the one or more antennas 1025. The transceiver 1015, or the transceiver 1015 and one or more antennas 1025, may be an example of a transmitter 615, a transmitter 715, a receiver 610, a receiver 710, or any combination thereof or component thereof, as described herein.

The memory 1030 may include RAM and ROM. The memory 1030 may store computer-readable, computer-executable, or processor-executable, such as code 1035. The code 1035 may include instructions that, when executed by the processor 1040, cause the device 1005 to perform various functions described herein. In some cases, the memory 1030 may include, among other things, a BIOS which may control basic hardware or software operation such as the interaction with peripheral components or devices.

The processor 1040 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting techniques for LDPC rate matching). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication in accordance with examples as disclosed herein. For example, the communications manager 1020 is capable of, configured to, or operable to support a means for generating one or more LDPC codewords based on performing LDPC encoding on data, each codeword of the one or more LDPC codewords including a respective set of data bits and a respective set of parity bits. The communications manager 1020 is capable of, configured to, or operable to support a means for adding one or more symbols or one or more symbol fractions to a first boundary of a packet to generate an adjusted first boundary, the first boundary specifying a first number of symbols of the packet allocated for the one or more LDPC codewords, where a puncturing ratio associated with the one or more LDPC codewords is reduced (e.g., from a first non-zero value to a second non-zero value) or set to zero. The communications manager 1020 is capable of, configured to, or operable to support a means for transmitting, to a second wireless device, the packet including the one or more LDPC codewords that includes a set of pre-FEC padding bits based on the adjusted first boundary.

Additionally, or alternatively, the communications manager 1020 may support wireless communication in accordance with examples as disclosed herein. For example, the communications manager 1020 is capable of, configured to, or operable to support a means for generating one or more codewords based on performing LDPC encoding on data, each of the one or more codewords including at least a respective set of parity bits and a respective set of data bits. The communications manager 1020 is capable of, configured to, or operable to support a means for adjusting a physical layer coded bits boundary associated with the one or more codewords to be a value that corresponds to a last symbol fraction of a last symbol of one or more symbols of a data field of a packet. The communications manager 1020 is capable of, configured to, or operable to support a means for mapping the one or more codewords to at least one symbol fraction of the last symbol of the one or more symbols based on the adjusted physical layer coded bits boundary. The communications manager 1020 is capable of, configured to, or operable to support a means for transmitting, to a second wireless device, the packet via the one or more symbols based on mapping the one or more codewords.

By including or configuring the communications manager 1020 in accordance with examples as described herein, the device 1005 may support techniques for improved communication reliability.

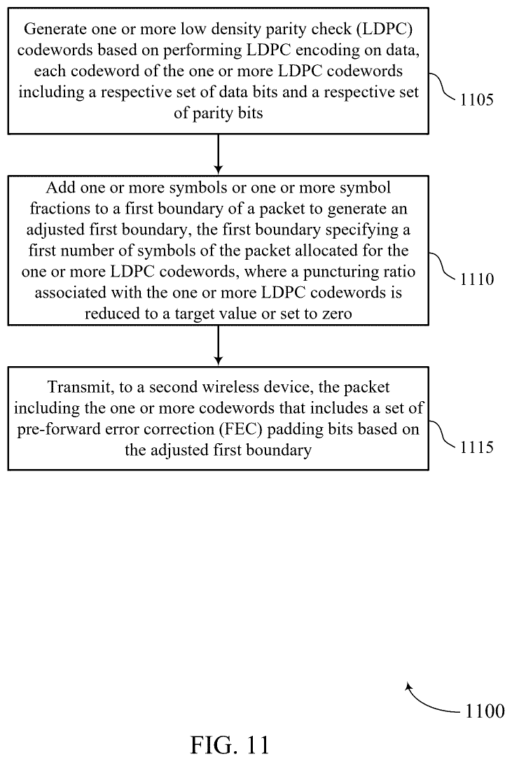

FIG. 11 shows a flowchart illustrating a method 1100 that supports techniques for LDPC rate matching in accordance with one or more aspects of the present disclosure. The operations of the method 1100 may be implemented by an AP or a STA or its components as described herein. For example, the operations of the method 1100 may be performed by an AP or a STA as described with reference to FIGS. FIG. 1 through 10. In some examples, an AP or a STA may execute a set of instructions to control the functional elements of the wireless AP or the wireless STA to perform the described functions. Additionally, or alternatively, the wireless AP or the wireless STA may perform aspects of the described functions using special-purpose hardware.

At 1105, the method may include generating one or more LDPC codewords based on performing LDPC encoding on data, each codeword of the one or more LDPC codewords including a respective set of data bits and a respective set of parity bits. The operations of 1105 may be performed in accordance with examples as disclosed herein. In some examples, aspects of the operations of 1105 may be performed by an encoding component 825 as described with reference to FIG. 8.

At 1110, the method may include adding one or more symbols or one or more symbol fractions to a first boundary of a packet to generate an adjusted first boundary, the first boundary specifying a first number of symbols of the packet allocated for the one or more LDPC codewords, where a puncturing ratio associated with the one or more LDPC codewords is reduced to a target value (e.g., from a first non-zero value to a second non-zero value) or set to zero. The operations of 1110 may be performed in accordance with examples as disclosed herein. In some examples, aspects of the operations of 1110 may be performed by a boundary adjustment component 830 as described with reference to FIG. 8.

At 1115, the method may include transmitting, to a second wireless device, the packet including the one or more LDPC codewords that includes a set of pre-FEC padding bits based on the adjusted first boundary. The operations of 1115 may be performed in accordance with examples as disclosed herein. In some examples, aspects of the operations of 1115 may be performed by a signal transmitter 835 as described with reference to FIG. 8.

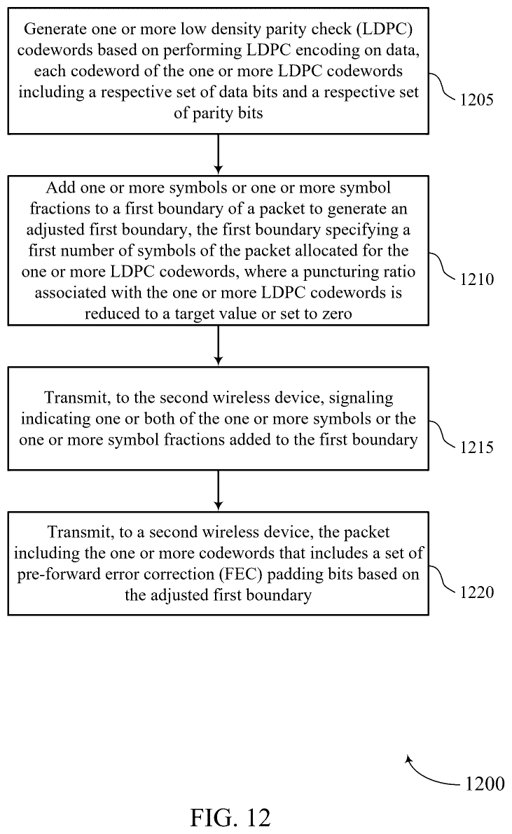

FIG. 12 shows a flowchart illustrating a method 1200 that supports techniques for LDPC rate matching in accordance with one or more aspects of the present disclosure. The operations of the method 1200 may be implemented by an AP or a STA or its components as described herein. For example, the operations of the method 1200 may be performed by an AP or a STA as described with reference to FIGS. FIG. 1 through 10. In some examples, an AP or a STA may execute a set of instructions to control the functional elements of the wireless AP or the wireless STA to perform the described functions. Additionally, or alternatively, the wireless AP or the wireless STA may perform aspects of the described functions using special-purpose hardware.

At 1205, the method may include generating one or more LDPC (LDPC) codewords based on performing LDPC encoding on data, each codeword of the one or more LDPC codewords including a respective set of data bits and a respective set of parity bits. The operations of 1205 may be performed in accordance with examples as disclosed herein. In some examples, aspects of the operations of 1205 may be performed by an encoding component 825 as described with reference to FIG. 8.

At 1210, the method may include adding one or more symbols or one or more symbol fractions to a first boundary of a packet to generate an adjusted first boundary, the first boundary specifying a first number of symbols of the packet allocated for the one or more LDPC codewords, where a puncturing ratio associated with the one or more LDPC codewords is reduced to a target value (e.g., from a first non-zero value to a second non-zero value) or set to zero. The operations of 1210 may be performed in accordance with examples as disclosed herein. In some examples, aspects of the operations of 1210 may be performed by a boundary adjustment component 830 as described with reference to FIG. 8.

At 1215, the method may include transmitting, to the second wireless device, signaling indicating one or both of the one or more symbols or the one or more symbol fractions added to adjust the first boundary. The operations of 1215 may be performed in accordance with examples as disclosed herein. In some examples, aspects of the operations of 1215 may be performed by a boundary adjustment component 830 as described with reference to FIG. 8.

At 1220, the method may include transmitting, to a second wireless device, the packet including the one or more LDPC codewords that includes a set of pre-FEC padding bits based on the adjusted first boundary. The operations of 1220 may be performed in accordance with examples as disclosed herein. In some examples, aspects of the operations of 1220 may be performed by a signal transmitter 835 as described with reference to FIG. 8.

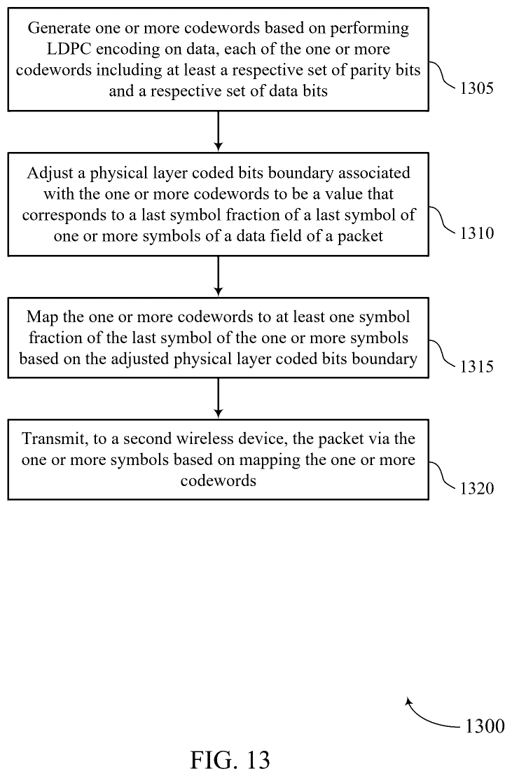

FIG. 13 shows a flowchart illustrating a method 1300 that supports techniques for LDPC rate matching in accordance with one or more aspects of the present disclosure. The operations of the method 1300 may be implemented by an AP or a STA or its components as described herein. For example, the operations of the method 1300 may be performed by an AP or a STA as described with reference to FIGS. FIG. 1 through 10. In some examples, an AP or a STA may execute a set of instructions to control the functional elements of the wireless AP or the wireless STA to perform the described functions. Additionally, or alternatively, the wireless AP or the wireless STA may perform aspects of the described functions using special-purpose hardware.

At 1305, the method may include generating one or more codewords based on performing LDPC encoding on data, each of the one or more codewords including at least a respective set of parity bits and a respective set of data bits. The operations of 1305 may be performed in accordance with examples as disclosed herein. In some examples, aspects of the operations of 1305 may be performed by an encoding component 825 as described with reference to FIG. 8.

At 1310, the method may include adjusting a physical layer coded bits boundary associated with the one or more codewords to be a value that corresponds to a last symbol fraction of a last symbol of one or more symbols of a data field of a packet. The operations of 1310 may be performed in accordance with examples as disclosed herein. In some examples, aspects of the operations of 1310 may be performed by a boundary adjustment component 830 as described with reference to FIG. 8.

At 1315, the method may include mapping the one or more codewords to at least one symbol fraction of the last symbol of the one or more symbols based on the adjusted physical layer coded bits boundary. The operations of 1315 may be performed in accordance with examples as disclosed herein. In some examples, aspects of the operations of 1315 may be performed by a mapping component 840 as described with reference to FIG. 8.

At 1320, the method may include transmitting, to a second wireless device, the packet via the one or more symbols based on mapping the one or more codewords. The operations of 1320 may be performed in accordance with examples as disclosed herein. In some examples, aspects of the operations of 1320 may be performed by a signal transmitter 835 as described with reference to FIG. 8.

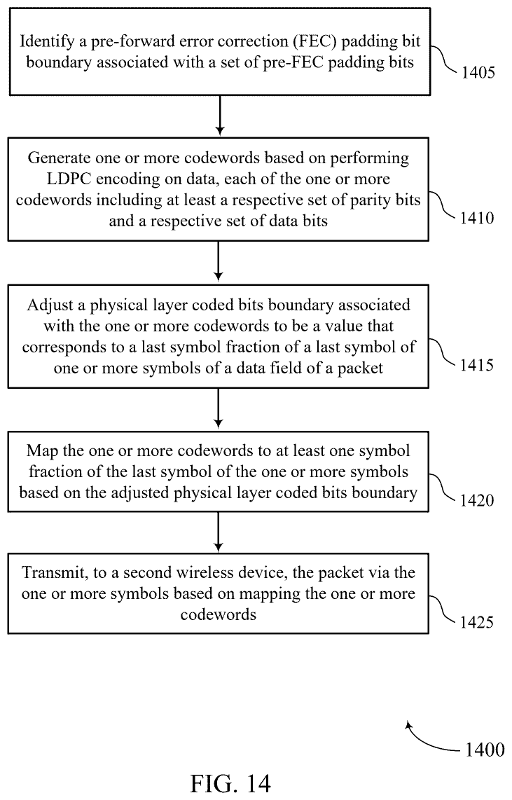

FIG. 14 shows a flowchart illustrating a method 1400 that supports techniques for LDPC rate matching in accordance with one or more aspects of the present disclosure. The operations of the method 1400 may be implemented by an AP or a STA or its components as described herein. For example, the operations of the method 1400 may be performed by an AP or a STA as described with reference to FIGS. FIG. 1 through 10. In some examples, an AP or a STA may execute a set of instructions to control the functional elements of the wireless AP or the wireless STA to perform the described functions. Additionally, or alternatively, the wireless AP or the wireless STA may perform aspects of the described functions using special-purpose hardware.

At 1405, the method may include identifying pre-FEC padding bit boundary associated with a set of pre-FEC padding bit boundary. In some examples, aspects of the operations of 1405 may be performed by a boundary adjustment component 830 as described with reference to FIG. 8.

At 1410, the method may include generating one or more codewords based on performing LDPC encoding on data, each of the one or more codewords including at least a respective set of parity bits and a respective set of data bits. The operations of 1410 may be performed in accordance with examples as disclosed herein. In some examples, aspects of the operations of 1410 may be performed by an encoding component 825 as described with reference to FIG. 8.

At 1415, the method may include adjusting a physical layer coded bits boundary associated with the one or more codewords to be a value that corresponds to a last symbol fraction of a last symbol of one or more symbols of a data field of a packet. The operations of 1415 may be performed in accordance with examples as disclosed herein. In some examples, aspects of the operations of 1415 may be performed by a boundary adjustment component 830 as described with reference to FIG. 8.

At 1420, the method may include mapping the one or more codewords to at least one symbol fraction of the last symbol of the one or more symbols based on the adjusted physical layer coded bits boundary. The operations of 1420 may be performed in accordance with examples as disclosed herein. In some examples, aspects of the operations of 1420 may be performed by a mapping component 840 as described with reference to FIG. 8.

At 1425, the method may include transmitting, to a second wireless device, the packet via the one or more symbols based on mapping the one or more codewords. The operations of 1425 may be performed in accordance with examples as disclosed herein. In some examples, aspects of the operations of 1425 may be performed by a signal transmitter 835 as described with reference to FIG. 8.

The following provides an overview of aspects of the present disclosure:

Aspect 1: A method for wireless communication at a first wireless device, comprising: generating one or more LDPC codewords based at least in part on performing LDPC encoding on data, each codeword of the one or more LDPC codewords comprising a respective set of data bits and a respective set of parity bits; adding one or more symbols or one or more symbol fractions to a first boundary of a packet to generate an adjusted first boundary, the first boundary specifying a first number of symbols of the packet allocated for the one or more LDPC codewords, wherein a puncturing ratio associated with the one or more LDPC codewords is reduced to a target value or set to zero; and transmitting, to a second wireless device, the packet comprising the one or more LDPC codewords that comprise a set of pre-FEC padding bits based at least in part on the adjusted first boundary.

Aspect 2: The method of aspect 1, further comprising: identifying a physical layer coded bits boundary that specifies a second number of symbols of the packet allocated for the one or more LDPC codewords, wherein the first boundary comprises a physical layer payload boundary, and wherein the physical layer coded bit boundary is based at least in part on the adjusted first boundary.

Aspect 3: The method of aspect 2, further comprising: mapping the one or more LDPC codewords to the second number of symbols of the packet and up to the physical layer coded bits boundary of the packet.

Aspect 4: The method of any of aspects 2 through 3, further comprising: transmitting, to the second wireless device, signaling indicating the physical layer coded bits boundary or a parameter associated with the physical layer coded bits boundary.

Aspect 5: The method of any of aspects 2 through 4, wherein the one or more LDPC codewords transmitted to the second wireless device comprise a nominal size of 648 bytes, 1296 bytes, 1944 bytes, or 3888 bytes that is based at least in part on the physical layer coded bits boundary.

Aspect 6: The method of aspect 5, wherein the one or more LDPC codewords transmitted to the second wireless device comprise the nominal size without shortening, puncturing, or repeating bits.

Aspect 7: The method of any of aspects 1 through 6, further comprising: transmitting, to the second wireless device, signaling indicating one or both of the one or more symbols or the one or more symbol fractions added to the first boundary.

Aspect 8: The method of any of aspects 1 through 7, further comprising: generating one or more second LDPC codewords based at least in part on performing the LDPC encoding on the data, each of the one or more second LDPC codewords comprising the respective set of data bits, a respective set of shortening bits, and the respective set of parity bits; and discarding the respective sets of shortening bits, wherein generating the one or more LDPC codewords is based at least in part on the one or more second LDPC codewords and on discarding the respective sets of shortening bits.

Aspect 9: The method of any of aspects 1 through 8, further comprising: mapping the one or more LDPC codewords and the set of pre-FEC padding bits to the first number of symbols of the packet and up to the adjusted first boundary of the packet.

Aspect 10: The method of any of aspects 1 through 9, wherein the packet further comprises a packet extension that spans a fixed duration of 0 microseconds, 4 microseconds, 8 microseconds, or 16 microseconds, the method further comprising: transmitting, to the second wireless device, signaling comprising an indication of the fixed duration of the packet extension.

Aspect 11: The method of any of aspects 1 through 10, wherein the puncturing ratio associated with the one or more LDPC codewords is reduced to the target value or set to zero based at least in part on a reduced puncturing associated with the adjusted first boundary compared to a puncturing associated with the first boundary.

Aspect 12: The method of any of aspects 1 through 11, wherein the packet further comprises a packet extension that spans a fixed duration.

Aspect 13: The method of any of aspects 1 through 12, wherein a symbol fraction comprises one or more symbol segments, each symbol segment spanning a fraction of a symbol, the fraction comprising ¼ of a symbol or ⅛ of a symbol.

Aspect 14: A method for wireless communication at a first wireless device, comprising: generating one or more codewords based at least in part on performing LDPC encoding on data, each of the one or more codewords comprising at least a respective set of parity bits and a respective set of data bits; adjusting a physical layer coded bits boundary associated with the one or more codewords to be a value that corresponds to a last symbol fraction of a last symbol of one or more symbols of a data field of a packet; mapping the one or more codewords to at least one symbol fraction of the last symbol of the one or more symbols based at least in part on the adjusted physical layer coded bits boundary; and transmitting, to a second wireless device, the packet via the one or more symbols based at least in part on mapping the one or more codewords.

Aspect 15: The method of aspect 15, further comprising: identifying a pre-forward error correction (FEC) padding bit boundary associated with a set of pre-FEC padding bits, wherein generating the one or more codewords is based at least in part on identifying a pre-FEC padding bit boundary, the one or more codewords comprising the set of pre-FEC padding bits.

Aspect 16: The method of aspect 15, further comprising: transmitting, to the second wireless device, signaling comprising one or more of an indication of the pre-FEC padding bit boundary an indication of a parameter associated with the pre-FEC padding bit boundary, or an indication that a condition has been satisfied.

Aspect 17: The method of any of aspects 14 through 16, further comprising: performing rate matching on the one or more codewords, wherein the rate matching comprises LDPC rate matching.

Aspect 18: The method of any of aspects 14 through 17, wherein the packet comprises a packet extension that spans a fixed duration of 0 microseconds, 4 microseconds, 8 microseconds, or 16 microseconds, the method further comprising: transmitting, to the second wireless device, signaling comprising an indication of the fixed duration of the packet extension.

Aspect 19: The method of any of aspects 14 through 18, wherein the packet further comprises a packet extension that spans a fixed duration.

Aspect 20: A first wireless device for wireless communication, comprising one or more memories storing processor-executable code, and one or more processors coupled with the one or more memories and individually or collectively operable to execute the code to cause the first wireless device to perform a method of any of aspects 1 through 13.

Aspect 21: A first wireless device for wireless communication, comprising at least one means for performing a method of any of aspects 1 through 13.

Aspect 22: A non-transitory computer-readable medium storing code for wireless communication, the code comprising instructions executable by one or more processors to perform a method of any of aspects 1 through 13.

Aspect 23: A first wireless device for wireless communication, comprising one or more memories storing processor-executable code, and one or more processors coupled with the one or more memories and individually or collectively operable to execute the code to cause the first wireless device to perform a method of any of aspects 14 through 19.

Aspect 24: A first wireless device for wireless communication, comprising at least one means for performing a method of any of aspects 13 through 18.

Aspect 25: A non-transitory computer-readable medium storing code for wireless communication, the code comprising instructions executable by one or more processors to perform a method of any of aspects 14 through 19.

It should be noted that the methods described herein describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, WLAN 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A first wireless device, comprising:
one or more memories storing processor-executable code; and
one or more processors coupled with the one or more memories and individually or collectively operable to execute the code to cause the first wireless device to:
generate one or more low density parity check (LDPC) codewords based at least in part on performance of LDPC encoding on data, each codeword of the one or more LDPC codewords comprising a respective set of data bits and a respective set of parity bits;
add one or more symbols or one or more symbol fractions to a first boundary of a packet to generate an adjusted first boundary, the first boundary specifying a first number of symbols of the packet allocated for the one or more LDPC codewords, wherein a puncturing ratio associated with the one or more LDPC codewords is reduced to a target value or set to zero; and
transmit, to a second wireless device, the packet comprising the one or more LDPC codewords that comprise a set of pre-forward error correction (FEC) padding bits based at least in part on the adjusted first boundary.

2. The first wireless device of claim 1, wherein the one or more processors are individually or collectively further operable to execute the code to cause the first wireless device to:
identify a physical layer coded bits boundary that specifies a second number of symbols of the packet allocated for the one or more LDPC codewords, wherein the first boundary comprises a physical layer payload boundary, and wherein the physical layer coded bits boundary is based at least in part on the adjusted first boundary.

3. The first wireless device of claim 2, wherein the one or more processors are individually or collectively further operable to execute the code to cause the first wireless device to:
map the one or more LDPC codewords to the second number of symbols of the packet and up to the physical layer coded bits boundary of the packet.

4. The first wireless device of claim 2, wherein the one or more processors are individually or collectively further operable to execute the code to cause the first wireless device to:
transmit, to the second wireless device, signaling indicating the physical layer coded bits boundary or a parameter associated with the physical layer coded bits boundary.

5. The first wireless device of claim 2, wherein the one or more LDPC codewords transmitted to the second wireless device comprise a nominal size of 648 bytes, 1296 bytes, 1944 bytes, or 3888 bytes that is based at least in part on the physical layer coded bits boundary.

6. The first wireless device of claim 5, wherein the one or more LDPC codewords transmitted to the second wireless device comprise the nominal size without shortening, puncturing, or repeating bits.

7. The first wireless device of claim 1, wherein the one or more processors are individually or collectively further operable to execute the code to cause the first wireless device to:
transmit, to the second wireless device, signaling indicating one or both of the one or more symbols or the one or more symbol fractions added to the first boundary.

8. The first wireless device of claim 1, wherein the one or more processors are individually or collectively further operable to execute the code to cause the first wireless device to:
generate one or more second LDPC codewords based at least in part on performance of the LDPC encoding on the data, each of the one or more second LDPC codewords comprising the respective set of data bits, a respective set of shortening bits, and the respective set of parity bits; and
discard the respective sets of shortening bits, wherein generation of the one or more LDPC codewords is based at least in part on the one or more second LDPC codewords and on the discard of the respective sets of shortening bits.

9. The first wireless device of claim 1, wherein the one or more processors are individually or collectively further operable to execute the code to cause the first wireless device to:
map the one or more LDPC codewords that includes the set of pre-FEC padding bits to the first number of symbols of the packet and up to the adjusted first boundary of the packet.

10. The first wireless device of claim 1, wherein the packet further comprises a packet extension that spans a fixed duration of 0 microseconds, 4 microseconds, 8 microseconds, 12 microseconds, or 16 microseconds, and the one or more processors are individually or collectively further operable to execute the code to cause the first wireless device to:
transmit, to the second wireless device, signaling comprising an indication of the fixed duration of the packet extension.

11. The first wireless device of claim 1, wherein the puncturing ratio associated with the one or more LDPC codewords is reduced to the target value or set to zero based at least in part on a reduced puncturing associated with the adjusted first boundary compared to a puncturing associated with the first boundary.

12. The first wireless device of claim 1, wherein the packet further comprises a packet extension that spans a fixed duration.

13. The first wireless device of claim 1, wherein a symbol fraction comprises one or more symbol segments, each symbol segment spanning a fraction of a symbol, the fraction comprising ¼ of a symbol or ⅛ of a symbol.

14. A first wireless device, comprising:
one or more memories storing processor-executable code; and
one or more processors coupled with the one or more memories and individually or collectively operable to execute the code to cause the first wireless device to:
generate one or more codewords based at least in part on performance of LDPC encoding on data, each of the one or more codewords comprising at least a respective set of parity bits and a respective set of data bits;
adjust a physical layer coded bits boundary associated with the one or more codewords to be a value that corresponds to a last symbol fraction of a last symbol of one or more symbols of a data field of a packet;
map the one or more codewords to at least one symbol fraction of the last symbol of the one or more symbols based at least in part on the adjusted physical layer coded bits boundary; and
transmit, to a second wireless device, the packet via the one or more symbols based at least in part on the mapped one or more codewords.

15. The first wireless device of claim 14, wherein the one or more processors are individually or collectively further operable to execute the code to cause the first wireless device to:
identify a pre-forward error correction (FEC) padding bit boundary associated with a set of pre-FEC padding bits, wherein generation of the one or more codewords is based at least in part on the identification of the pre-FEC padding bit boundary, the one or more codewords comprising the set of pre-FEC padding bits.

16. The first wireless device of claim 15, wherein the one or more processors are individually or collectively further operable to execute the code to cause the first wireless device to:
transmit, to the second wireless device, signaling comprising one or more of an indication of the pre-FEC padding bit boundary, an indication of a parameter associated with the pre-FEC padding bit boundary, or an indication that a condition has been satisfied.

17. The first wireless device of claim 14, wherein the one or more processors are individually or collectively further operable to execute the code to cause the first wireless device to:
perform rate matching on the one or more codewords, wherein the rate matching comprises low density parity check (LDPC) rate matching.

18. The first wireless device of claim 14, wherein the packet comprises a packet extension that spans a fixed duration of 0 microseconds, 4 microseconds, 8 microseconds, 12 microseconds, or 16 microseconds, and the one or more processors are individually or collectively further operable to execute the code to cause the first wireless device to:
transmit, to the second wireless device, signaling comprising an indication of the fixed duration of the packet extension.

19. The first wireless device of claim 14, wherein the packet further comprises a packet extension that spans a fixed duration.

20. A method for wireless communication at a first wireless device, comprising:
generating one or more low density parity check (LDPC) codewords based at least in part on performance of LDPC encoding on data, each codeword of the one or more LDPC codewords comprising a respective set of data bits and a respective set of parity bits;
adding one or more symbols or one or more symbol fractions to a first boundary of a packet to generate an adjusted first boundary, the first boundary specifying a first number of symbols of the packet allocated for the one or more LDPC codewords, wherein a puncturing ratio associated with the one or more LDPC codewords is reduced to a target value or set to zero; and
transmitting, to a second wireless device, the packet comprising the one or more LDPC codewords that comprise a set of pre-forward error correction (FEC) padding bits based at least in part on the adjusted first boundary.

21. The method of claim 20, further comprising:
identifying a physical layer coded bits boundary that specifies a second number of symbols of the packet allocated for the one or more LDPC codewords, wherein the first boundary comprises a physical layer payload boundary, and wherein the physical layer coded bits boundary is based at least in part on the adjusted first boundary.

22. The method of claim 20, wherein the one or more LDPC codewords transmitted to the second wireless device comprise a nominal size without shortening, puncturing, or repeating bits.

23. The method of claim 20, further comprising:
transmitting, to the second wireless device, signaling indicating one or both of the one or more symbols or the one or more symbol fractions added to the first boundary.

24. The method of claim 20, further comprising:
generating one or more second LDPC codewords based at least in part on performance of the LDPC encoding on the data, each of the one or more second LDPC codewords comprising the respective set of data bits, a respective set of shortening bits, and the respective set of parity bits; and
discarding the respective sets of shortening bits, wherein generating the one or more LDPC codewords is based at least in part on the one or more second LDPC codewords and on the discard of the respective sets of shortening bits.

25. The method of claim 20, further comprising:
mapping the one or more LDPC codewords that includes the set of pre-FEC padding bits to the first number of symbols of the packet and up to the adjusted first boundary of the packet.

26. The method of claim 20, wherein the packet further comprises a packet extension that spans a fixed duration of 0 microseconds, 4 microseconds, 8 microseconds, 12 microseconds, or 16 microseconds, the method further comprising:
transmitting, to the second wireless device, signaling comprising an indication of the fixed duration of the packet extension.

27. The first wireless device of claim 20, wherein the puncturing ratio associated with the one or more LDPC codewords is reduced to the target value or set to zero based at least in part on a reduced puncturing associated with the adjusted first boundary compared to a puncturing associated with the first boundary.

28. A method for wireless communication at a first wireless device, comprising:
generating one or more codewords based at least in part on performance of low density parity check (LDPC) encoding on data, each of the one or more codewords comprising at least a respective set of parity bits and a respective set of data bits;
adjusting a physical layer coded bits boundary associated with the one or more codewords to be a value that corresponds to a last symbol fraction of a last symbol of one or more symbols of a data field of a packet;
mapping the one or more codewords to at least one symbol fraction of the last symbol of the one or more symbols based at least in part on the adjusted physical layer coded bits boundary; and
transmitting, to a second wireless device, the packet via the one or more symbols based at least in part on the mapped one or more codewords.

29. The method of claim 28, further comprising:
identifying a pre-forward error correction (FEC) padding bit boundary associated with a set of pre-FEC padding bits, wherein generating the one or more codewords is based at least in part on identification of the pre-FEC padding bit boundary, the one or more codewords comprising the set of pre-FEC padding bits.

30. The method of claim 28, further comprising:
performing rate matching on the one or more codewords, wherein the rate matching comprises LDPC rate matching.
